(19) United States
(12) Patent Application Publication
(10) Pub. No.: US 2006/0046728 A1
(43) Pub. Date: Mar. 2, 2006

(54) Cellular mobile communication system and method using heterogeneous wireless network

(75) Inventors: Heung-Chul Jung, Suwon-si (KR); Sang-Jun Moon, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/211,473

(22) Filed: Aug. 26, 2005

(30) Foreign Application Priority Data
Aug. 27, 2004 (KR) 2004-68154
Nov. 5, 2004 (KR) 2004-90066

(51) Int. Cl. H04Q 7/20

(52) U.S. Cl. 455/445

(57) ABSTRACT

A cellular mobile communication system and method for using a heterogeneous wireless network are provided. The system includes an access point of a wireless LAN (Local Area Network) for providing a wireless resource using a wireless LAN-dedicated frequency; a base station of a cellular network connected with the access point through a wired network and setting up a first tunnel; and a terminal for setting up a second tunnel with the access point using the wireless resource provided from the access point, and connecting to the cellular network through the first and second tunnels to perform call processing.

### PRIORITY

This application claims the benefit under 35 U.S.C. §119(a) of applications for CELLULAR MOBILE COMMUNICATION SYSTEM AND METHOD USING HETEROGENEOUS WIRELESS NETWORK filed in the Korean Intellectual Property Office on Aug. 27 2004 and duly assigned Serial No. 2004-68154 and filed on Nov. 05, 2004 and duly assigned Serial No. 2004-90066, the entire disclosures of both of which are hereby incorporated by reference.

### BACKGROUND OF THE INVENTION

1. Field of the Invention

The present invention relates to a heterogeneous network. More specifically, the present invention relates to a cellular mobile communication system and method using a heterogeneous wireless network, in which connection to a cellular service network can be made using a wireless resource of a wireless network using a wireless frequency other than a cellular frequency of the cellular mobile communication system, even without using a cellular service-dedicated wireless resource, thereby providing a cellular service.

2. Description of the Related Art

A cellular mobile communication system is based on the concept of overcoming limitations in service area and subscriber capacity. In the cellular mobile communication system, a service area is divided into several smaller zones called cells so that the same frequency band can be used in two cells separated by a sufficient distance, thereby spatially reusing frequency. Accordingly, the cellular mobile communication system can secure sufficient subscribers by increasing the number of spatially distributed channels.

FIG. 1 shows a network construction of a cellular mobile communication system.

Referring to FIG. 1, the cellular mobile communication system includes a Base Station Controller (BSC) 5, a Base Transceiver System (BTS) 6, and a cellular terminal 7.

The BTS 6 performs two-way conversion between wired and wireless signals, covers one cell/sector area, and manages a plurality of terminals 7 included in the cell/sector area.

The BSC 5 manages and controls the BTSs 6. In detail, the BSC 5 assigns and de-assigns a wireless channel for each cellular terminal 7, controls a transmission output of each cellular terminal 7 and each BTS 6, performs a soft handoff between cells and determines a hard handoff between cells, performs functions of trans coding (16 kbps U 64 kbps) and vocoding (13 kbps, 8 kbps), performs a function of GPS clock distribution for handoff and signal processing, and performs management and maintenance for each BTS 6.

The BSC 5 is connected to an MSC 3, which is a voice core network connected with a Public Switched Telephone Network (PSTN) 4 for voice communication, and to a Packet Data Serving Node (PDSN) 2, which is a data core network connected to the Internet 1 for data communication.

The MSC 3 performs an exchange function for voice communication using the cellular mobile communication system, and the PDSN 2 performs a packet exchange function for data communication using the cellular mobile communication system.

In the cellular mobile communication system, call processing between the cellular terminal 7 and the BTS 6 is classified into two kinds: call processing of the cellular terminal 7 and call processing of the BTS 6.

The call processing of the BTS 6 includes pilot and synch channel processing, paging channel processing, access channel processing, and traffic channel processing. During pilot channel processing, the BTS 6 transmits a pilot channel signal. During traffic channel processing, the BTS 6 communicates with the cellular terminal 7, which is in a state of mobile station control on the traffic channel, using forward and reverse traffic channels. During access channel processing, the BTS 6 monitors an access channel and receives messages from the cellular terminal 7 in a system access state. During paging channel processing, the BTS 6 transmits messages on a paging channel monitored by the cellular terminal 7 which is in the system access state or an idle state.

In the cellular terminal 7, call processing is performed in four terminal states: an initialization state, an idle state, a system access state, and a mobile station control on the traffic channel state. In the initialization state, the cellular terminal 7 selects and acquires a mobile communication system for communication. In the system access state, the cellular terminal 7 transmits messages to the BTS 6 on the access channel, and receives messages from the BTS 6 on the assigned paging channel. In the mobile station control on the traffic channel state, the cellular terminal 7 communicates with the BTS 6 through the forward and reverse traffic channels.

Wireless Local Area Networks (WLANs) are designed to enable high-speed wireless data service based on Ethernet standards. WLANs have been utilized as network solutions useful for a factory, a conference room, a showroom, and anywhere it is difficult or inconvenient to setup up wired network cables.

The WLAN is based on radio waves, not a physical cable as in a wired LAN. The WLAN employing radio waves has a longer communication range than a network employing infrared rays, and has no difficulty in data exchange even if there are minor obstacles. A 2.4 GHz frequency band of the WLAN is different from a frequency band of wireless devices such as portable phones and cordless phones, and accordingly, the WLAN is not affected by line-crossing and also does not require a service license. Further, the WLAN can be used at any location since it does not need a WLAN cable.

FIG. 2 shows a construction of a WLAN system.

Referring to FIG. 2, the WLAN system includes a WLAN terminal 15 having a Network Interface Card (NIC) mounted thereon; a WLAN access point 14 for wirelessly communicating with the WLAN terminal 15 using the WLAN frequency; a router 13 for connecting the access point 14 to an external network; and a gateway 12 for connecting the access point 14 to the Internet 11 through the router 13.

In a definition of WLAN Media Access Control (MAC) of IEEE 802.11, the access point 14 performs authentication and association to manage its WLAN service area.

In other words, when the WLAN terminal 15 requests a call connection, the access point 14 receives information on call connection, that is, information on Internet Protocol (IP), gateway, and Domain Name Server (DNS) previously setup in the WLAN terminal 15, from the corresponding WLAN terminal 15, requests the gateway 12 for connection authentication through the router 13, and performs a function of WLAN relay for call connection.

If a registered member identifier (ID) and password are input through the WLAN terminal 15, the WLAN terminal 15 is authenticated for call connection in the gateway 12. If the gateway 12 permits the connection authentication, the corresponding WLAN terminal 15 sets up the wireless link through the access point 14 and connects the call through the gateway 12.

As described above, since the WLAN system and the cellular mobile communication system provide services using different frequency bands, they have been developed as separate systems.

However, in line with the recent general trend toward universalization of communications technology, technology for linking various heterogeneous communication networks is required. In particular, there is a need for technology for linking the WLAN system and the cellular mobile communication network.

### SUMMARY OF THE INVENTION

It is an objective of embodiments of the present invention to provide a cellular mobile communication system and method for using a heterogeneous wireless network, which enable a cellular mobile communication service in a wireless network environment using wireless frequencies other than a cellular-dedicated frequency, such as a wireless LAN.

Another object of embodiments of the present invention is to provide a cellular mobile communication system and method for using a heterogeneous wireless network, which support handover to secure terminal mobility in the heterogeneous wireless network.

According to an aspect of the present invention, there is provided a cellular mobile communication system for using a heterogeneous wireless network. The system includes an access point of a wireless LAN (Local Area Network) for providing a wireless resource using a wireless LAN-dedicated frequency. A base station of a cellular network is connected with the access point through a wired network by setting up a first tunnel. A terminal sets up a second tunnel with the access point using the wireless resource provided from the access point, and connects to the cellular network through the first and second tunnels to perform call processing.

According to another aspect to the present invention, there is provided a terminal for a cellular mobile communication system for using a heterogeneous wireless network. The terminal includes a Wireless Local Area Network (WLAN) interface module assigned a wireless resource from a WLAN that communicates with the WLAN using a WLAN-dedicated frequency band. A tunnel processor sets up and manages a second tunnel with the WLAN which sets up a first tunnel with a cellular network, using the wireless resource provided from the WLAN through the WLAN interface module. A call processor connects to the cellular network through the first and second tunnels and performs call processing.

According to still another aspect of the present invention, there is provided a cellular mobile communication method for using a heterogeneous wireless network. The method includes setting up a first tunnel with a base station of a cellular network connected through a wire network in an access point of a wireless Local Area Network (WLAN). A second tunnel is set up with a terminal connected through a wireless link in the access point of the WLAN. The terminal is connected to the cellular network through the first and second tunnels and performs call processing.

According to yet another aspect of the present invention, there is provided a handover device of a cellular mobile communication system for using a heterogeneous wireless network. The system includes an access point of a wireless Local Area Network (WLAN) for providing a wireless resource using a wireless LAN-dedicated frequency. A base station of a cellular network connects with the access point through a wired network and sets up a first tunnel. A terminal sets up a second tunnel with the access point using the wireless resource provided from the access point, connects to the cellular network through the first and second tunnels or using a wireless resource provided from the cellular network, and, if it is determined that a handover is required, sets up a new channel according to the handover and connects to the cellular network through the new channel.

According to still yet another aspect of the present invention, there is provided a handover method in a cellular mobile communication system for using a heterogeneous wireless network where a cellular network and a wireless LAN are connected through a tunnel. The method includes determining whether or not the terminal needs handover, and when it is determined that the terminal needs a handover, setting up a first tunnel with the wireless LAN in order to create a new channel to be used for data transmission after the handover. A second tunnel is set up for connecting the wireless LAN with the cellular network. Data is communicated to and from the cellular network through the newly created channel having the first and second tunnels.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which:

FIG. 1 shows a network construction of a conventional cellular mobile communication system;

FIG. 2 shows a construction of a conventional wireless LAN system;

FIG. 3 shows a construction of a cellular mobile communication system using a wireless LAN according to an embodiment of the present invention;

FIG. 4 shows a construction of a terminal according to an embodiment of the present invention;

FIG. 5 is a block diagram showing an exemplary access point according to an embodiment of the present invention;

FIG. 6 shows a protocol stack structure of a cellular mobile communication system using a heterogeneous wireless network according to an embodiment of the present invention;

FIG. 7 shows a protocol stack structure of a cellular mobile communication system using a heterogeneous wireless network according to another embodiment of the present invention;

FIG. 8 shows a protocol stack structure of a cellular mobile communication system using a heterogeneous wireless network according to another embodiment of the present invention;

FIG. 9 is a call processing flowchart when there is an incoming call in a cellular mobile communication system using a heterogeneous wireless network according to an embodiment of the present invention;

FIG. 10 is a call processing flowchart when there is an outgoing call in a cellular mobile communication system using a heterogeneous wireless network according to an embodiment of the present invention;

FIG. 11A shows a handover when a terminal moves from a cellular network to a wireless LAN network, in a heterogeneous network where a tunnel is setup between the terminal and an enhanced Base Station Controller (eBSC) according to an embodiment of the present invention;

FIG. 11B is a call flowchart for performing the handover of FIG. 11A in a case where there is no tunnel between an enhanced Access Point (eAP) of the wireless LAN and the eBSC of the cellular network;

FIG. 11C is a call flowchart for performing the handover of FIG. 11A in a case where there is a tunnel between the eAP of the wireless LAN and the eBSC of the cellular network;

FIG. 11D shows a protocol stack in a CDMA2000 1X data service used in the handover of FIG. 11A;

FIG. 12A shows a handover when a terminal moves from a wireless LAN network to a cellular network in a heterogeneous network where a tunnel is setup between the terminal and an eBSC according to an embodiment of the invention;

FIG. 12B is a call flowchart for performing the handover of FIG. 12A;

FIG. 12C shows a protocol stack for the handover of FIG. 12A;

FIG. 13A shows a handover performed in a Mobile Station Controller (MSC) for a terminal moving between a cellular network and a wireless LAN network according to an embodiment of the invention;

FIG. 13B is a call flowchart for performing a handover in a case where a terminal receiving a voice service in a cellular area as shown in FIG. 13A moves to a wireless LAN area;

FIG. 13C is a call flowchart for performing a handover in a case where a terminal receiving a voice service in a wireless LAN area as shown in FIG. 13A moves to a cellular area;

FIG. 14A shows a handover performed for a terminal moving between a cellular network and a wireless LAN network, in a Packet Data Serving Node (PDSN) according to an embodiment of the invention;

FIG. 14B is a protocol stack for performing a handover when a terminal receiving a data service in a cellular area as shown in FIG. 14A moves to a wireless LAN area;

FIG. 14C is a protocol stack for performing a handover when a terminal receiving a data service in a wireless LAN area as shown in FIG. 14A moves to a cellular area;

FIG. 15 shows a construction of a cellular mobile communication system for using a heterogeneous wireless network according to another embodiment of the present invention;

FIG. 16 shows a protocol stack structure of a cellular mobile communication system for using a heterogeneous wireless network according to an embodiment of the present invention;

FIG. 17 shows a protocol stack structure of a cellular mobile communication system for using a heterogeneous wireless network according to another embodiment of the present invention;

FIG. 18 shows a protocol stack structure of a cellular mobile communication system for using a heterogeneous wireless network according to another embodiment of the present invention;

FIG. 19 is a call processing flowchart when there is an incoming call in a cellular mobile communication system using a heterogeneous wireless network according to an embodiment of the present invention;

FIG. 20 is a call processing flowchart when there is an outgoing call in a cellular mobile communication system using a heterogeneous wireless network according to an embodiment of the present invention; and

FIG. 21 shows a handover when a terminal moves between a cellular network and a wireless LAN network, in a heterogeneous network where a tunnel is setup between the terminal and an eBSC, according to an embodiment of the present invention.

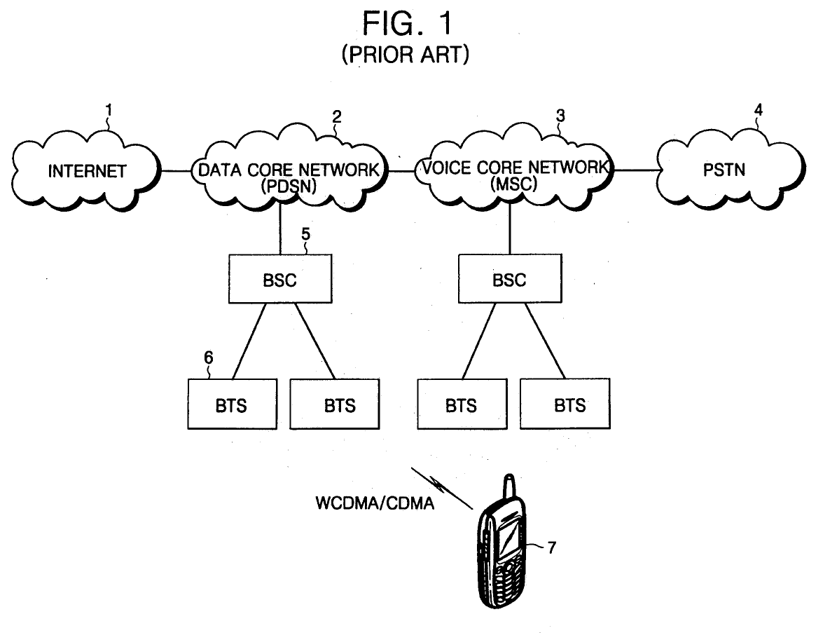

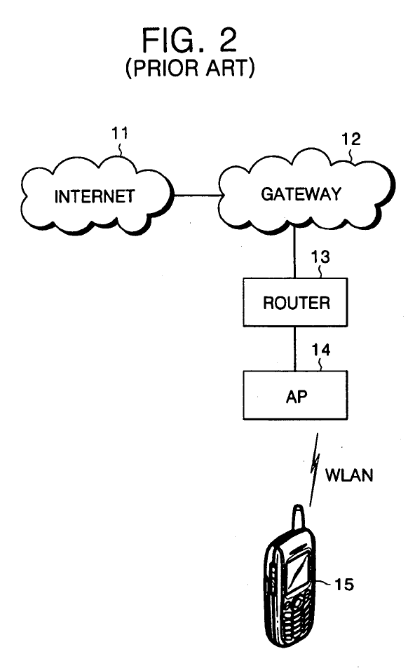

Throughout the drawings, like reference numbers will be understood to refer to like elements, features and structures.

### DETAILED DESCRIPTION OF EXEMPLARY EMBODIMENTS

Exemplary embodiments of the present invention will now be described more fully with reference to the accompanying drawings.

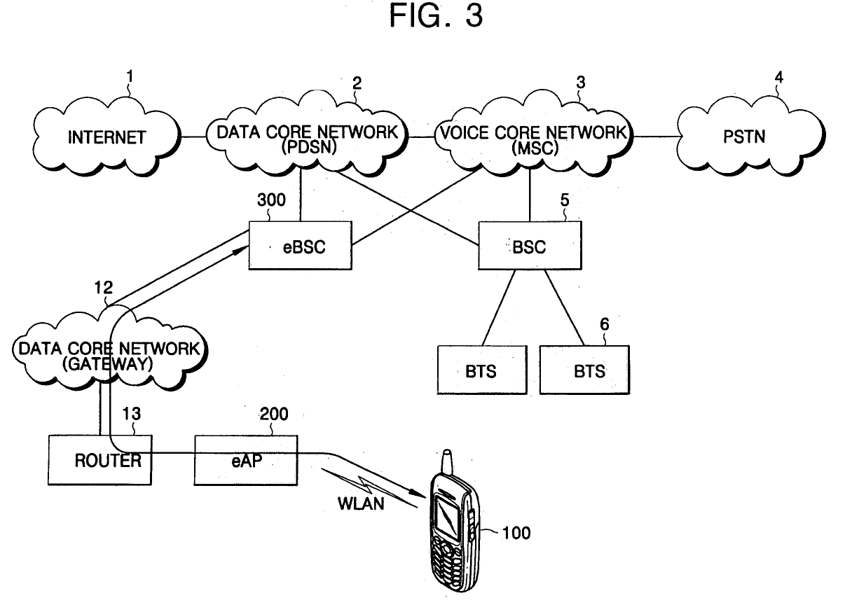

FIG. 3 shows a construction of a cellular mobile communication system for using a Wireless Local Area Network (WLAN) according to an exemplary embodiment of the present invention.

Referring to FIG. 3, the exemplary mobile communication system includes a terminal 100 having a Wireless Local Area Network (WLAN) interface card mounted therein. An enhanced Access Point (Hereinafter, referred to as “eAP”) 200 wirelessly communicates with the terminal 100 using a WLAN frequency and sets up a tunnel with the terminal 100. A switch or router 13 connects the eAP 200 to an external network. A gateway 12 connects the eAP 200 to the Internet through the switch or router 13. An enhanced Base Station Controller (Hereinafter, referred to as “eBSC”) 300 connected to the gateway 12 through a wired network sets up a tunnel with the eAP 200 through the wired network, and provides a cellular service to the terminal 100 through the tunnel.

The eBSC 300 of FIG. 3 transmits data communicated to or from the terminal 100 that isconnected through the tunnel to a Mobile Station Controller (MSC) 3 or a Packet Data Serving Node (PDSN) 2. The eBSC 300 manages and controls base stations including all eBTSs and BTSs, and provides a cellular communication service for the terminal 100 connected through the wireless LAN. In other words, the eBSC 300 has a function of setting up a tunnel with the terminal 100 connected through the wireless LAN, in addition to a function of a BSC, and can preferably perform the same functions as a conventional BSC. That is, the eBSC 300 can also perform a handover function of deciding whether or not to perform handover and processing a handover when it decides to do so.

A Wireless Local Area Network (WLAN) interface module is mounted in the terminal 100 and processes a wireless signal at the WLAN frequency. The terminal 100 sets up a wireless link with the eAP 200 using the WLAN frequency in a WLAN area, performs wireless communication through the wireless link, sets up a tunnel with the eAP 200, and connects to a cellular network through the tunnel. Hereinafter, unless otherwise stated, the terminal 100 is considered to be a terminal having the WLAN interface module for setting up the wireless link with the eAP using the WLAN frequency.

The terminal 100 can be mainly realized in at least two types. In a first type, the terminal 100 includes the WLAN interface module for setting up the wireless link using only the WLAN frequency.

In a second type, the terminal 100 includes both the WLAN interface module and a cellular wireless interface module for processing the wireless signal at the cellular frequency. In the second type, the terminal 100 can set up the wireless link using the WLAN frequency in the WLAN area and using a cellular frequency in a cellular area. Accordingly, the second type terminal can perform a handover from a WLAN area to a cellular area, and vice versa.

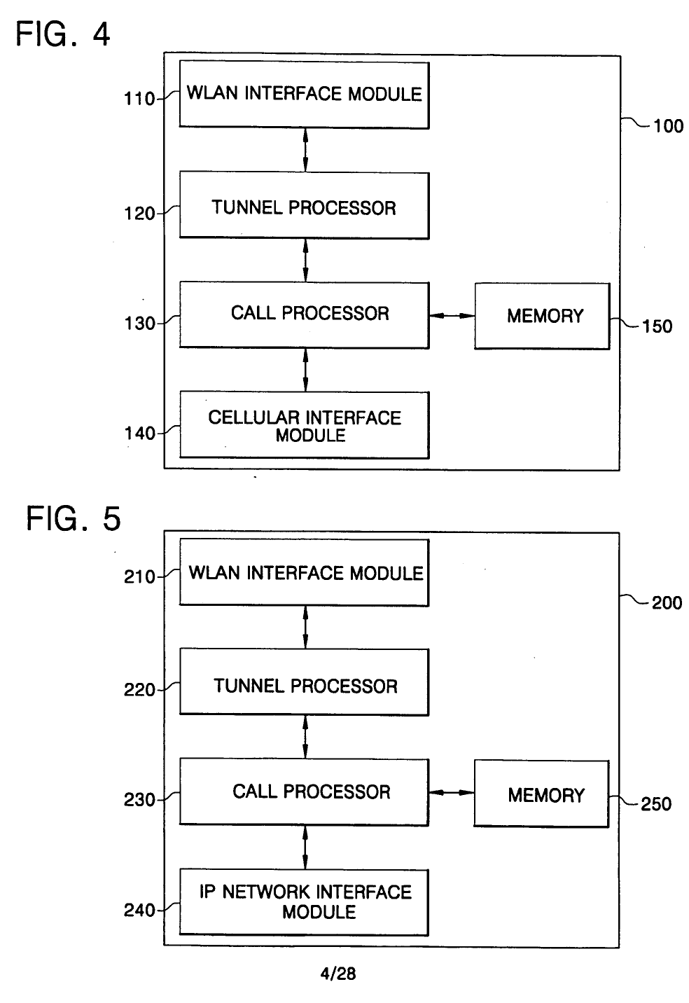

FIG. 4 shows a an example of the second type terminal according to an embodiment of the present invention.

Referring to FIG. 4, the terminal 100 includes a WLAN interface module 110 that is assigned a wireless resource from the WLAN and communicates with the WLAN using a WLAN-dedicated frequency band. A tunnel processor 120 sets up and manages a tunnel with the eBSC 300 of a cellular network connected to the WLAN through the wired network using the wireless resource provided from the WLAN through the WLAN interface module 110. A call processor 130 is connected to the cellular network through the tunnel set up by the tunnel processor 120 and performs call processing. A cellular interface module 140 assigns the wireless resource from the cellular network using a cellular-dedicated frequency band and communicates with the cellular network. A memory 150 stores tunnel setup information.

The eAP 200 preferably communicates with the terminal 100 using Carrier Sense Multiple Access/Collision Avoidance (CSMA/CA) protocols of the IEEE 802.11 standard.

FIG. 5 is a block diagram showing an example of an eAP according to an embodiment of the present invention.

Referring to FIG. 5, the eAP 200 includes a WLAN interface module 210 for assigning the wireless resources from the WLAN and setting up a wireless link with the WLAN using a WLAN-dedicated frequency band. An Internet Protocol (IP) network interface module 240 communicates with an IP network. A tunnel processor 220 sets up a tunnel with the terminal 100 through the wireless link setup by the WLAN interface module 210, sets up a tunnel with the eBSC 300 through the wired network connected by the IP network interface module 240, and manages each of the tunnels. A call processor 230 performs call processing so that the terminal 100 connects to the eBSC 300 of the cellular network through the tunnel setup by the tunnel processor 220. A memory 250 stores tunnel setup information.

The eAP 200 and the terminal 100 first check whether or not there is a carrier based on the CSMA/CA. If it is determined that there is no such carrier (that is, there is no terminal using a wireless channel), transmission is performed after a predetermined time lapse. Since the same transmitter (Tx) or receiver (Rx) uses air as a transmission medium, only one of transmission (Tx) and reception (Rx) can be performed at a time.

Further, in the event of a collision with another terminal in transmission, a next carrier is determined using a back-off algorithm.

The eBSC 300 is connected to a Mobile Station Controller (MSC) 3 which is a voice core network connected with a Public Switched Telephone Network (PSTN) 4 and performing voice communication, and a Packet Data Serving Node (PDSN) 2 which is a data core network connected to the Internet 1 and performing a data communication. The MSC 3 performs an exchange function for voice communication using the cellular mobile communication system, and the PDSN 2 performs a packet exchange function for data communication using the cellular mobile communication system.

The eBSC 300 manages and controls base stations (not shown), and provides a service for the terminal 100 connected through the WLAN.

In other words, the eBSC 300 assigns and de-assigns the wireless channel to a cellular terminal (not shown) for wirelessly communicating using the cellular frequency band, controls a transmission output of the cellular terminal and a Base Transceiver System (BTS) (not shown), performs a soft handoff between cells and determines a hard handoff between cells, performs trans coding (16 kbps⇄64 kbps) and vocoding (13 kbps, 8 kbps), performs GPS clock distribution for handoff and signal processing, and performs management and maintenance of the BTS (not shown).

Further, the eBSC 300 receives information from the terminal 100 connected through the tunnel in the WLAN area, and transmits the received information to the MSC 3 or the PDSN 2.

The terminal 100 receives a beacon from the eAP 200, performs an association process for the eAP 200 using the received beacon, and is assigned an IP address from a gateway 12 preferably using Dynamic Host Configuration Protocol (DHCP). After that, the terminal 100 sets up a tunnel to the eAP 200 using a tunneling method such as User Datagram Protocol (UDP).

A procedure for setting up a tunnel between the terminal 100 and the eAP 200 will now be described in more detail.

After the terminal 100 sets up an association with the eAP 200 of the WLAN, tunnel setup is attempted.

The tunnel setup can be performed manually by a manager or automatically at the terminal 100 and the eAP 200, respectively. Here, a process of automatically setting up the tunnel will be described in detail.

Depending on a method of setting up the tunnel between the terminal 100 and the eAP 200, various exemplary embodiments can be realized. Here, an embodiment using a Media Access Control (MAC) address, an embodiment using an IP address, and an embodiment using an IP address and a User Datagram Protocol (UDP) port number together will be described.

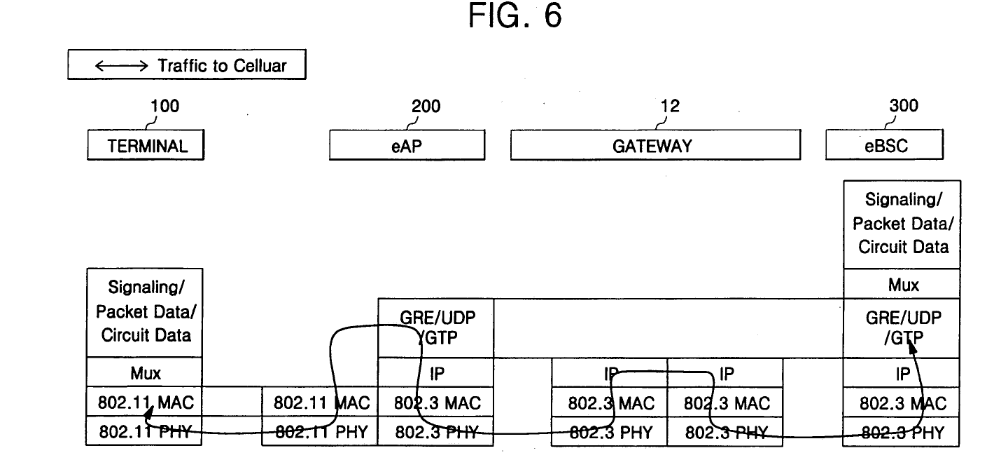

FIG. 6 shows an exemplary protocol stack structure of the cellular mobile communication system for using a heterogeneous wireless network according to an embodiment of the present invention.

An embodiment where a tunnel is setup between the terminal 100 and the eAP 200 using a MAC address will be described with reference to FIG. 6.

The terminal 100 and the eAP 200 can communicate in a MAC layer without intermediate assistance of other networks. Accordingly, the eAP 200 and the terminal 100 can be aware of each other's MAC address. In a case where the terminal 100 and the eAP 200 previously determine whether or not to setup a tunnel, they setup the tunnel using their own MAC addresses without any separate messages.

Otherwise, the terminal 100 transmits a tunnel connection setup request to the eAP 200, and then the eAP 200 transmits a tunnel connection permission message to the terminal 100.

After that, the eAP 200 transmits all traffic to or from the terminal 100 with which the tunnel is setup through the tunnel setup with the eBSC 300.

Meanwhile, though not illustrated in the drawings, one terminal 100 can include two MAC addresses, one of which is designated to use the tunnel setup with the eBSC 300, and the other of which can be designated to use the IP data network.

In this case, if a MAC address uploaded from the terminal 100 is designated to form a tunnel for the cellular service, the eAP 200 can transmit the MAC address to the eBSC 300 through the tunnel, and if it is designated for the IP data network, the eAP 200 can transmit the MAC address to the corresponding IP data network.

Next, an operation for setting up a tunnel between the eAP 200 and the eBSC 300 will be described below.

An operation for setting up a tunnel between the eAP 200 and the eBSC 300 can be performed when the eAP 200 is powered on, and when the terminal 100 enters a WLAN area managed by the eAP 200 and requests a tunnel set up between the terminal 100 and the eAP 200.

Even when a tunnel is already setup between the eAP 200 and the eBSC 300, an additional tunnel may be set up depending on a security level or a Quality of Service (QoS).

The eAP 200 first transmits a tunnel setup request message to the eBSC 300. Various methods can be employed to determine which eBSC 300 to transmit to. For example, the eAP 200 can send a DNS query to a DNS server to find out the IP address of the eBSC 300.

After obtaining the IP address of the eBSC 300, the eAP 200 adds information to the tunnel setup request message, and transmits the tunnel setup request message. The information can include, for example, a type of tunneling protocol, the IP address of the eAP, a port address or a key value of the tunneling protocol, a tunneling protocol parameter (security level or quality of service), and so on.

When the eBSC 300 responds, information on success or failure of the tunnel setup, the port address or the key value of the tunneling protocol, and information on the security level/quality of service licensed by the eBSC 300 are added and a message is transmitted.

Even after the tunnel setup, a value of the tunnel setup can be changed upon request by the eAP 200 or the eBSC 300.

A process of setting up a tunnel from the eAP 200 up to the eBSC 300 will now be described in more detail.

In a case where a UDP tunnel from the eAP 200 up to the eBSC 300 is used, the eAP 200 transmits the tunnel setup request message to the eBSC 300 using the IP address of the eBSC 300 stored in the eAP 200.

This message can include an identifier (ID) (IP address, MAC address, and the like) of the eAP 200, a user ID (for example, Network Access Identifier (NAI)), or an International Mobile Subscriber Identity (IMSI)), and can include information on a kind of data (CS signaling, CS data, PS signaling, PS data, and the like).

The eBSC 300 receives the tunnel setup request message from the eAP 200, and periodically transmits a message having BSC related information such as a cell ID, through a source port number of the corresponding eAP 200. By doing so, the UDP tunnel between the eAP 200 and the eBSC 300 is completed so that information can be continuously exchanged using the UDP tunnel.

After completion of the tunnel, the eAP 200 does not ordinarily need to separately include an eAP ID and the user ID. The eBSC 300 regularly transmits information on the cell ID and states of other networks to the terminal 100 through the eAP 200.

In this example, a multiplexing layer (Mux) is used to distinguish between signaling, packet data, and circuit data transmitted between the terminal 100 and the eBSC 300. For example, a Mux header preferably having a total size of four bytes is defined, one byte is used as an identifier for identifying data as signaling, packet data, or circuit data, and the remaining bytes are left as a reserved field for future use.

The terminal 100 periodically transmits a position registration message of the cellular service to the eBSC 300. Even when there is no data to be transmitted, the message is preferably transmitted within a predetermined time in order to maintain the tunnel. If there is no tunnel maintenance message from the terminal 100, the eBSC 300 transmits an instant registration request message to the terminal 100 via the eAP 200 and waits for a predetermined time. For example, when the eBSC 300 transmits the registration request message three times and does not receive a response, it instructs the eAP 200 to cancel the tunnel with the terminal 100.

If the terminal 100 does not receive periodic network information from the eBSC 300, it transmits a message requesting the eBSC 300 to transmit the network information, and waits for a predetermined time. If there is no response after a predetermined time lapse, the terminal 100 repeats the same operation a predetermined number of times, for example, three times. If the network information is still not received, the terminal 100 cancels the tunnel with the eAP 200 and initiates a process of setting up a new tunnel.

Unlike a conventional BSC managing a BTS and performing a function of assigning a wireless channel to a terminal and controlling transmission output of a base station, the eBSC 300 commits the wireless resource of the WLAN to the WLAN eAP 200 and does not take any separate measures.

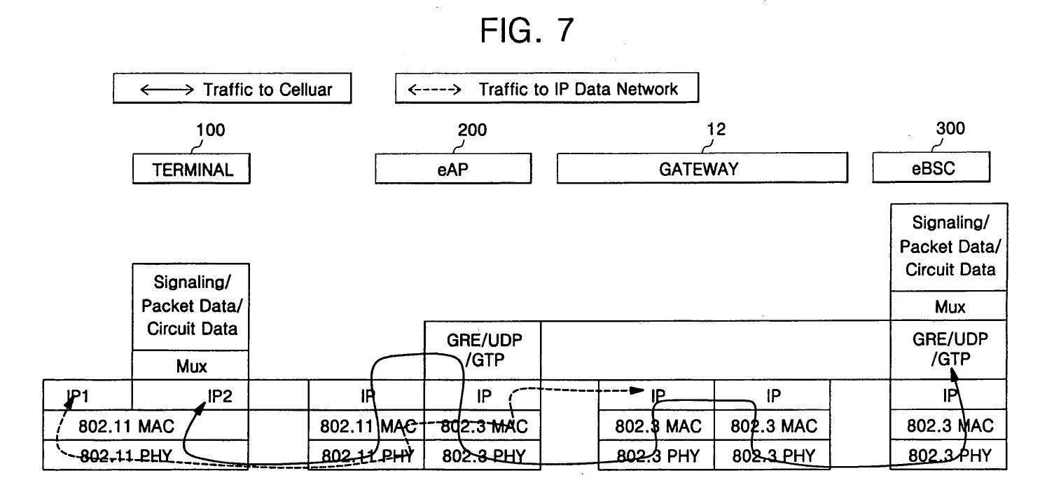

FIG. 7 shows a protocol stack structure of a cellular mobile communication system for using a heterogeneous wireless network according to another embodiment of the present invention.

Here, an operation for setting up the tunnel between the eAP 200 and the eBSC 300 is substantially the same as described with reference to FIG. 6.

An embodiment where a tunnel is setup between the terminal 100 and the eAP 200 using an IP address will now be described with reference to FIG. 7.

The eAP 200 can be of a type where connection is made with the IP network using an IP address, or of a type where traffic of the eAP 200 is relayed to a router using a MAC bridge. Here, the type where connection is made with the IP network using the IP address will be described as an example.

In order to perform tunnel setup using an IP address, the terminal 100 transmits a tunnel connection request message, together with the IP address of the terminal 100, to the eAP 200. The eAP 200 adds its own IP address and transmits the tunnel connection permission message to the terminal 100.

After that, the terminal 100 can distinguish between cellular traffic that should be transmitted to the cellular network and general IP data traffic that should be transmitted through the WLAN by using different IP addresses.

For example, a case in which a first IP address is used for general IP data traffic that should be transmitted through the WLAN and a second IP address is used for cellular traffic that should be transmitted to the cellular network will be described.

An IP packet having a header formed using the first IP address, transmitted from the terminal 100 to the eAP 200, is transmitted to the WLAN through the IP data network using the IP stack of the eAP 200 itself.

Meanwhile, an IP packet having a header formed using the second IP address, transmitted from the terminal 100 to the eAP 200, is mapped to a tunnel interface between the eAP 200 and the eBSC 300 by the tunnel setup, and transmitted to the cellular network.

At this time, a multiplexing layer (Mux) is used to distinguish whether the information transmitted between the terminal 100 and the eBSC 300 is signaling, packet data, or circuit data. For example, a Mux header having a total size of four bytes is preferably defined. One byte is preferably used as an identifier for distinguishing between signaling, packet data, and circuit data, and the remaining three bytes are left as a reserved field for future use.

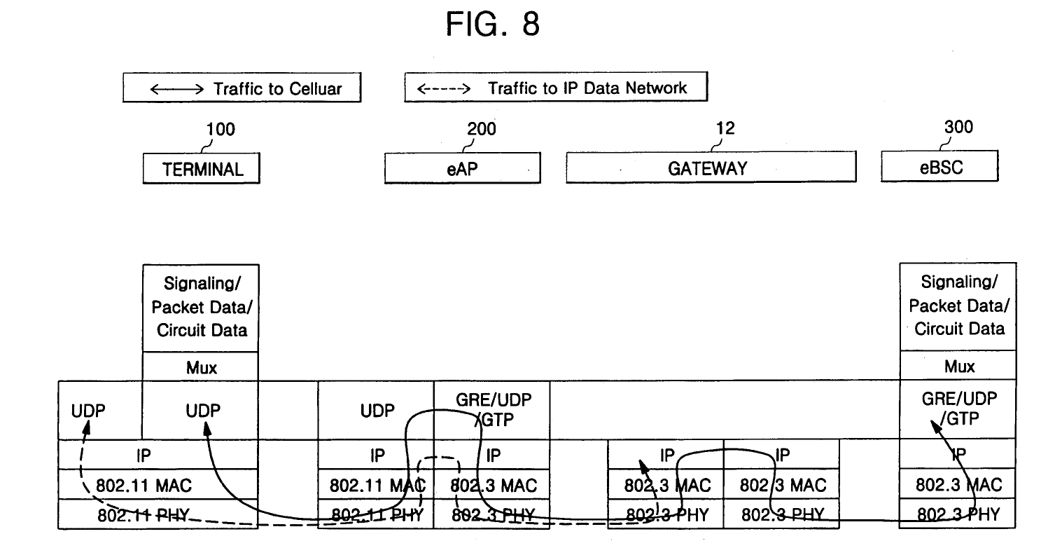

FIG. 8 shows a protocol stack structure of a cellular mobile communication system for using a heterogeneous wireless network according to another embodiment of the present invention.

Here, an operation for setting up the tunnel between the eAP 200 and the eBSC 300 is substantially the same as described with reference to FIG. 6.

An exemplary embodiment where a tunnel is setup between the terminal 100 and the eAP 200 using an IP address and a UDP port number together will now be described with reference to FIG. 8.

In order to perform the tunnel setup between the terminal 100 and the eAP 200 using an IP address and a UPD port number, the terminal 100 adds the IP address of the terminal 100 and a range of the UPD port number requesting the tunnel setup, and transmits the tunnel connection request to the eAP 200.

The eAP 200 adds the IP address of the eAP 200 and the range of the UDP port numbers requesting the tunnel setup, and transmits a tunnel connection permission message to the terminal 100.

Consequently, the terminal 100 can distinguish between cellular traffic and different IP data traffic using different UDP ports.

Traffic having a UDP header using UDP port numbers other than those designated for tunneling in a tunnel setup message is transmitted from the eAP 200 to the IP data network of the WLAN through its own IP stack.

Traffic having a UDP header using a UDP port number designated for tunneling in the tunnel setup message is mapped to the tunnel interface between the eAP 200 and the eBSC 300 by the tunnel setup and transmitted to the cellular network. A multiplexing layer (Mux) is used to distinguish whether information transmitted between the terminal 100 and the eBSC 300 is signaling, packet data, or circuit data. For example, a Mux header preferably having a total size of four bytes is defined. One byte is preferably used as an identifier for distinguishing between signaling, packet data, and circuit data, and the remaining three bytes are left as a reserved field for future use.

A process of performing cellular service in a terminal located in a WLAN area in communication systems as described above will be described below.

First, a connection between the eBSC 300 and the MSC 3 according to an embodiment of the present invention is preferably the same as a conventional connection between the BSC and the MSC, and uses a conventional message format for messages sent between the BSC and the MSC for call processing.

In other words, in the conventional art, if the MSC transmits a channel assignment request message to the BSC, the BSC commands the BTS according to the channel assignment request message and assigns a wireless channel to the terminal. And, when the BTS assigns the wireless channel to the terminal, the BSC performs a process for informing the MSC that the wireless channel assignment has been successfully completed.

The conventional channel assignment request message communicated between the MSC and the BSC for channel assignment can also be employed for communication between the eBSC 300 and the MSC 3 according to embodiments of the present invention. However, the channel assignment request message communicated between the eBSC 300 and the MSC 3 according to embodiments of the present invention only use the format of the conventional channel assignment request message, not a conventional message for commanding the assignment of the wireless channel. Accordingly, even when the channel assignment request message is communicated, processes of assigning the wireless resource of the cellular network as in the conventional cellular network are not needed. This is because, according to embodiments of the present invention, the wireless link uses the wireless resource assigned by the eAP 200 of the WLAN.

Accordingly, the MSC 3 sends the channel assignment request message to the eBSC 300 merely to inform it that the corresponding terminal has been called, and the eBSC 300 sends a response message to the MSC 3 merely to inform it that the terminal recognizes the fact that it is being called. Now an exemplary incoming call process will be described.

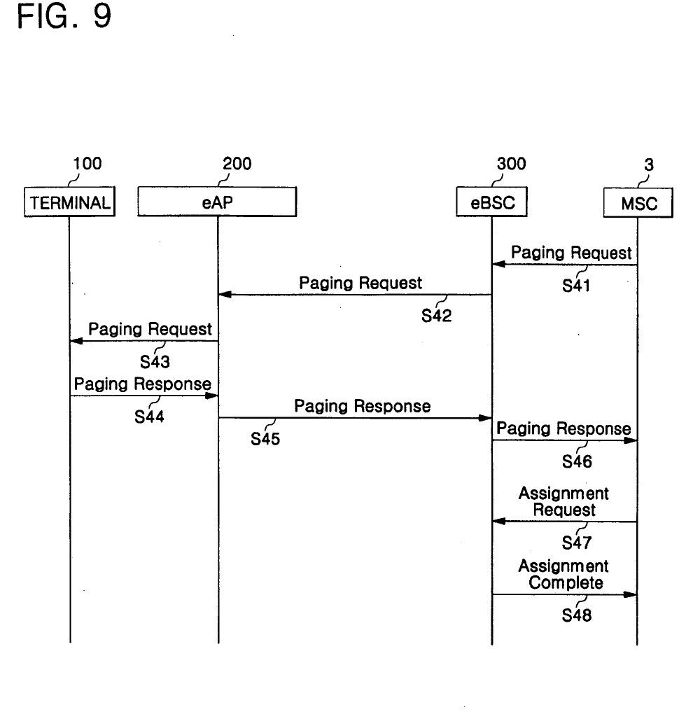

FIG. 9 is a call processing flowchart when there is an incoming call in a cellular mobile communication system using a heterogeneous wireless network according to an embodiment of the present invention.

Referring to FIG. 9, when the eBSC 300 receives a paging request message from the MSC 3 (Step 41), it transmits the paging request message to the eAP 200 through the setup tunnel (Step 42). The eAP 200 transmits a message requesting a response to the terminal 100 through the setup tunnel (Step 43). When the terminal 100 responds with a paging response message (Step 44), the eAP 200 transmits the paging response message to the eBSC 300 through the setup tunnel (Step 45). After the eBSC 300 confirms this response, it transmits the paging response message to the MSC 3 (Step 46). The paging response message transmitted from the eBSC 300 includes information on eBSC 300's requesting to setup a trunk channel with the MSC 3. In response, the MSC 3 transmits the channel assignment request message (Step 47) while completing setup of the trunk channel with the eBSC 300, and the eBSC 300 transmits a channel assignment complete message to the MSC 3 (Step 48).

Here, as the eBSC 300 and the MSC 3 both share trunk channel information with each other, the eBSC 300 adds information of a trunk channel not in service to the paging response message transmitted to the MSC 3. Accordingly, the MSC 3 recognizes the trunk channel information added to the paging response message received from the eBSC 300, sets up the trunk channel, loads the corresponding trunk channel information without change onto the channel assignment request message, and transmits it to the eBSC 300.

In another exemplary embodiment, the MSC 3 can also setup the trunk channel regardless of the trunk channel information added to the paging response message received from the eBSC 300, and load information on the setup trunk channel onto the channel assignment request message and transmit it to the eBSC 300. In this case, the trunk channel information can be included in the channel assignment request message, rather than in the paging response message.

Next, an outgoing call process will be described.

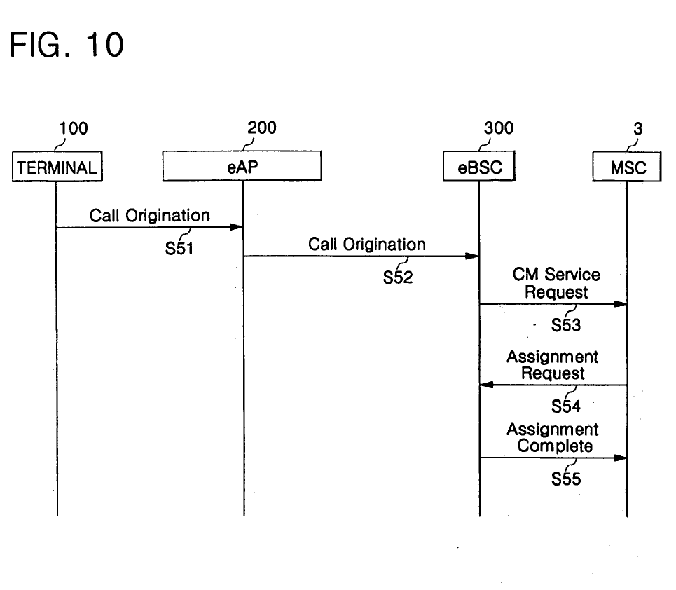

FIG. 10 is a call processing flowchart when there is an outgoing call in a cellular mobile communication system using a heterogeneous wireless network according to an embodiment of the present invention.

Referring to FIG. 10, the terminal 100 transmits an origination message to the eAP 200 using a predetermined tunnel (Step 51). The eAP 200 receives the origination message and transmits it to the eBSC 300 using the predetermined tunnel (Step 52).

The eBSC 300 receives the origination message, transmits a CM service request message to the MSC 3, and requests to setup a trunk channel (Step 53).

The MSC 3 responds to the eBSC 300 with the channel assignment request message and completes setup of the trunk channel between the MSC 3 and the eBSC 300 (Step 54), and the eBSC 300 transmits the channel assignment complete message to the MSC 3 (Step 55).

Here, as the eBSC 300 and the MSC 3 both share trunk channel information with each other, the eBSC 300 adds information identifying a trunk channel not in service to the CM service request message transmitted to the MSC 3. Accordingly, the MSC 3 recognizes the trunk channel information added to the CM service request message received from the eBSC 300, sets up the trunk channel, loads the corresponding trunk channel information without change onto the channel assignment request message, and transmits it to the eBSC 300.

In another exemplary embodiment, the MSC 3 can also setup the trunk channel regardless of the trunk channel information added to the CM service request message received from the eBSC 300, and load information on the setup trunk channel onto the channel assignment request message and transmit it to the eBSC 300. In this case, the trunk channel information can be included in the channel assignment request message, rather than in the CM service request message.

However, in a heterogeneous network connected through a tunnel, there is a case where the terminal 100 moves from one network to another heterogeneous network. In this case, a handover should be performed in a system. The handover can be divided into a process of detecting movement of the terminal from one area to another and a process of setting up a new communication channel after movement. A handover function, that is, a decision as to whether or not to perform the handover and handover processing based on the decision can be performed in the BSC. However, in general, the handover is requested by the terminal.

The terminal 100 can setup the wireless link using the WLAN interface module 102 in a WLAN area, and setup the wireless link using a cellular frequency in a cellular area. The terminal 100 according to an embodiment of the present invention makes it possible to perform a handover between two networks when moving between a WLAN area and a cellular area, owing to the wireless link that can be setup in both areas.

The terminal 100 normally determines whether a handover is required, and if so, requests the handover. In general, the terminal 100 determines that the handover is required when the intensity of a signal received through an earlier channel is less than a predetermined critical value. Of course, at this time, the terminal 100 should be able to receive another signal having a larger intensity than the signal received through the earlier channel, through a different channel. The handover of the terminal 100 refers to a process of receiving a communication service through the different channel instead of the earlier channel.

The handover in the heterogeneous network where the tunnel is setup between the terminal 100 and the eBSC 300 will now be described.

The handover in the heterogeneous network where the tunnel is setup between the terminal 100 and the eBSC 300 can be described for three cases of handover between BSCs, handover in the MSC 3, and handover in the PDSN 212.

First, the handover between BSCs will be described.

Handover between the BSCs can be divided into two cases. The first case occurs when the handover is performed when the terminal 100 moves from the cellular network to the WLAN network. The second case occurs when the terminal 100 moves from the WLAN network to the cellular network.

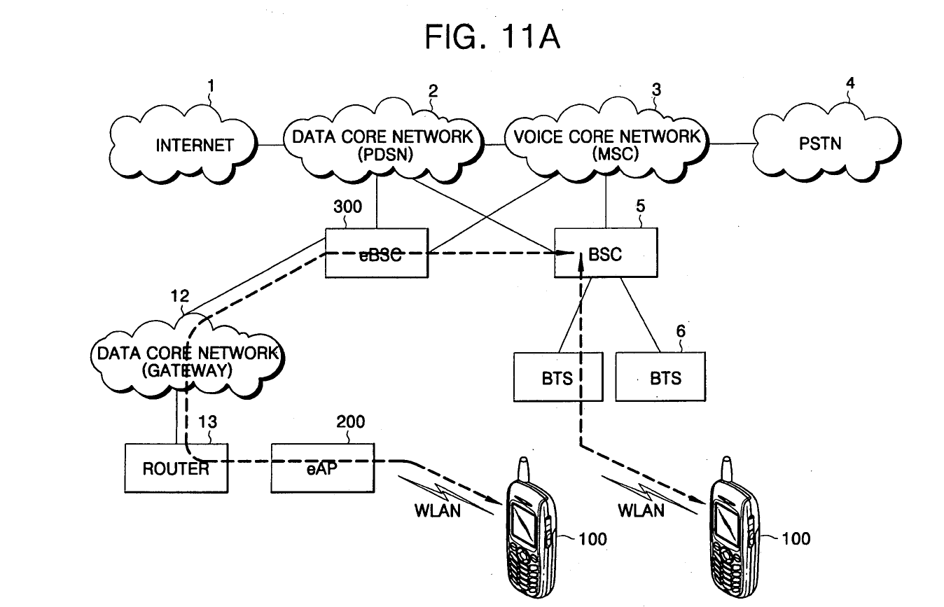

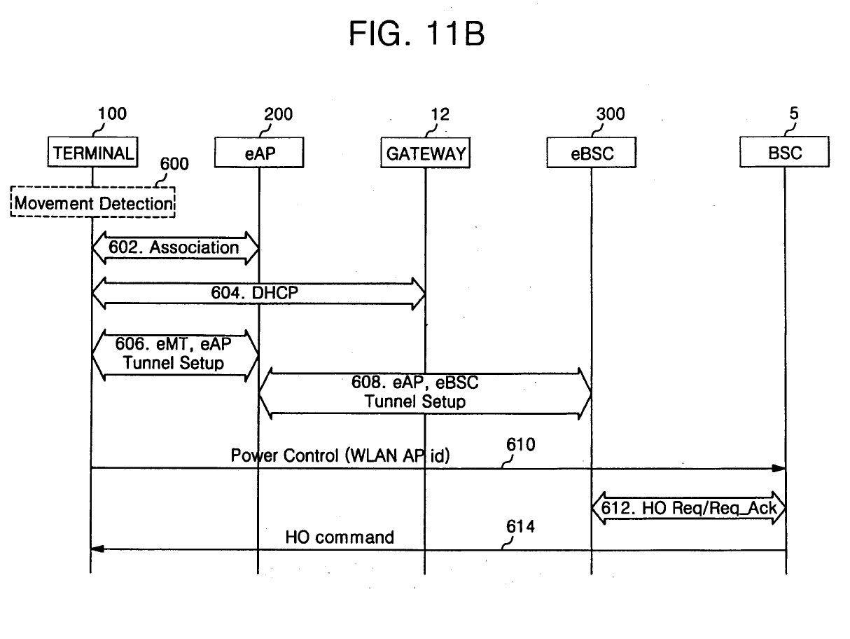

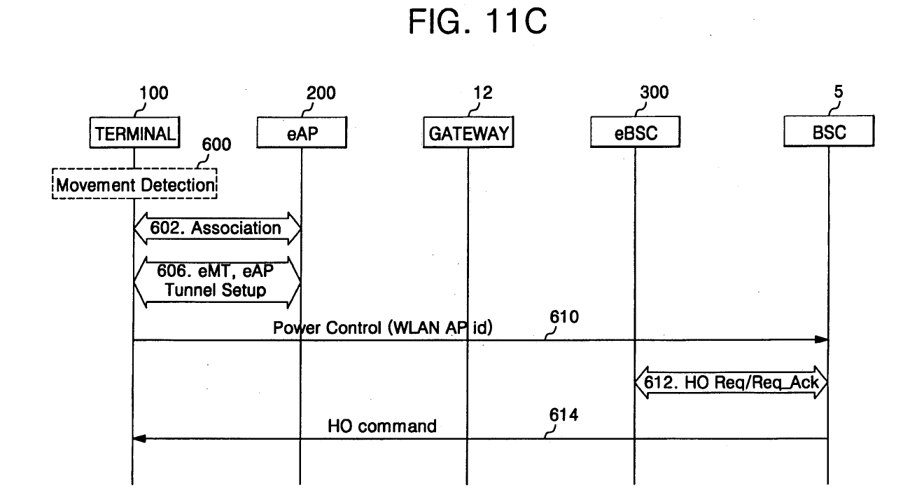

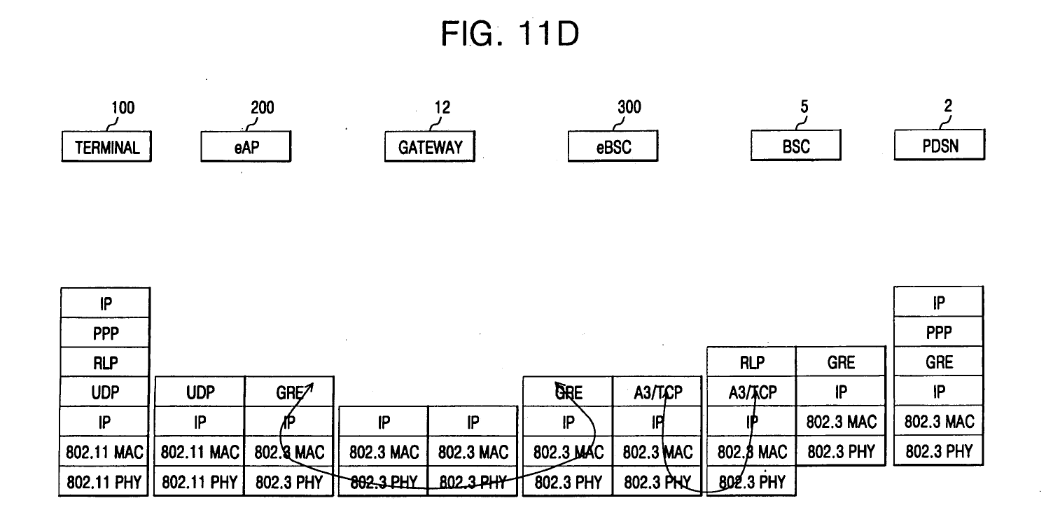

FIG. 11A shows a handover when the terminal moves from a cellular network to a wireless LAN network, in a heterogeneous network where a tunnel is setup between the terminal and the eBSC.

As shown in FIG. 11A, after the terminal 100 receiving the communication service from the cellular network through the traffic channel connected through the BTS 6 and the BSC 5 in the cellular network area moves to the WLAN area, it receives the communication service through a new traffic channel connected through an eAP 200, a router 13, a gateway 12, an eBSC 300, and the BSC 5. At this time, the terminal 100 sets up a tunnel with the eBSC 300 so as to setup a new traffic channel. The tunnel setup is performed through the eAP 200. In other words, the terminal 100 requests the eAP 200 to setup a tunnel and the eAP 200 sets up a tunnel with the corresponding eBSC 300, thereby setting up a tunnel between the terminal 100 and the eBSC 300.

Meanwhile, the handover shown in FIG. 11A is performed with the BSC 5 operating in the conventional cellular network operating as an anchor. The tunnel setup is performed between the terminal 100 and the eBSC 300, and therefore the eBSC 300 operates in the same manner as other BSCs from the perspective of the BSC 5. Therefore, a call flow of the handover between the BSCs can advantageously be performed according to a conventional cellular standard.

FIG. 11B is a call flowchart for performing the handover of FIG. 11A in a case where there is no tunnel established between the AP of the WLAN and the eBSC of the cellular network.

In a case where the terminal 100 intends to create a channel connected with a new eBSC 300 due to a handover, the channel can be created through the tunnel setup between the terminal 100 and the eAP 200 and the tunnel setup between the eAP 200 and the eBSC 300. However, there may be cases where the tunnel between the terminal 100 and the eAP 200 is setup but the tunnel between the eAP 200 and the eBSC 300 is not setup. FIG. 11B is a call flowchart for performing the handover in a case where there is no earlier tunnel between the eAP 200 and the eBSC 300.

In FIG. 11B, there is no tunnel established between the terminal 100 and the eBSC 300, and therefore the tunnel setup between the terminal 100 and the eAP 200 and the tunnel setup between the eAP 200 and the eBSC 300 should both be performed to setup the new channel for the handover.

In Step 600 of FIG. 11B, the terminal 100 detects a change of its location area, thereby recognizing the need for a handover. Here, the terminal 100 detects weakening of the signal received from the BTS 6 to determine change in its location area. When the terminal recognizes the need for a handover, it performs association 602 targeting the eAP 200, IP address acquisition 604 through a Dynamic Host Configuration Protocol (DHCP) targeting the gateway 12, and tunnel setup 606 targeting the eAP 200 to be newly connected to.

Upon receipt of a request from the terminal 100 for handover tunnel setup, the eAP 200 requests the corresponding eBSC 300 for the tunnel setup, and performs the tunnel setup with the eBSC 300 (Step 608). By doing so, the tunnel between the terminal 100 and the eBSC 300 is set up, and a channel to be used for data transmission of a handover call is created. Here, when the channel is setup for the handover, the tunnel setup process is included because embodiments of the present invention are applied to the heterogeneous network associated using the tunnel.

When the tunnel is setup, the terminal 100 transmits a message to the earlier BSC 5 requesting handover to a new BSC, that is, to the eBSC 300 (Step 610). This message can be transmitted using a power control message. Further, this message includes information on the eBSC 300 which is set as a new channel. After that, the handover is performed through exchange of a handover request message and a response message between the BSC 5 which is the earlier BSC and the eBSC 300 which is the new BSC (Step 612). After the handover, data transmission between the BSC 5 and the eBSC 300 can employ an A7 protocol which is a CDMA 2000 1X standard for transmitting data between BSCs. A handover command is transmitted from BSC 5 to terminal 100 at step 614.

Meanwhile, there also is a case where there is an earlier tunnel between the eAP 200 and the eBSC 300. In this case, the tunnel setup process between the eAP 200 and the eBSC 300 can be omitted.

FIG. 11C is a call flowchart for performing the handover shown in FIG. 11A in a case where there is a tunnel between the eAP of the WLAN and the eBSC of the cellular network.

As shown in FIG. 11C, the tunnel setup process 608 between the eAP 200 and the eBSC 300 of FIG. 11B is omitted. Therefore, the handover process can be performed as follows.

In Step 600 of FIG. 11C, the terminal 100 detects a change of its location area, thereby recognizing the need for a handover. When the terminal recognizes the time point of the handover, it performs association 602 targeting the eAP 200, IP address acquisition 604 through a Dynamic Host Configuration Protocol (DHCP) targeting the gateway 12 (not shown), and tunnel setup 606 targeting the eAP 200 to be newly connected to.

Upon receipt of a request from the terminal 100 for handover tunnel setup, the eAP 200 uses the earlier tunnel to the eBSC 300 without requiring a separate process for setting up such a tunnel.

By doing so, the tunnel between the terminal 100 and the eBSC 300 is set up, and a channel to be used for data transmission of a handover call is created. Subsequent processes are substantially the same as shown in FIG. 11B.

FIG. 11D shows a protocol stack in a CDMA2000 1X data service, used in the handover process illustrated in FIG. 11A.

It can be appreciated that an inter-BSC handover channel is setup between the BSC 5 which the terminal 100 uses before the handover for connection through the cellular network, and the eBSC 300 that the terminal 100 uses after the handover for connection through the WLAN, thereby managing traffic. FIG. 11D is based on the assumption that a Generic Routing Encapsulation (GRE) tunnel is setup between the eAP 200 and the eBSC 300. The eAP 200 checks the UDP port number transmitted from the terminal 100 and sorts data to be transmitted to the GRE tunnel.

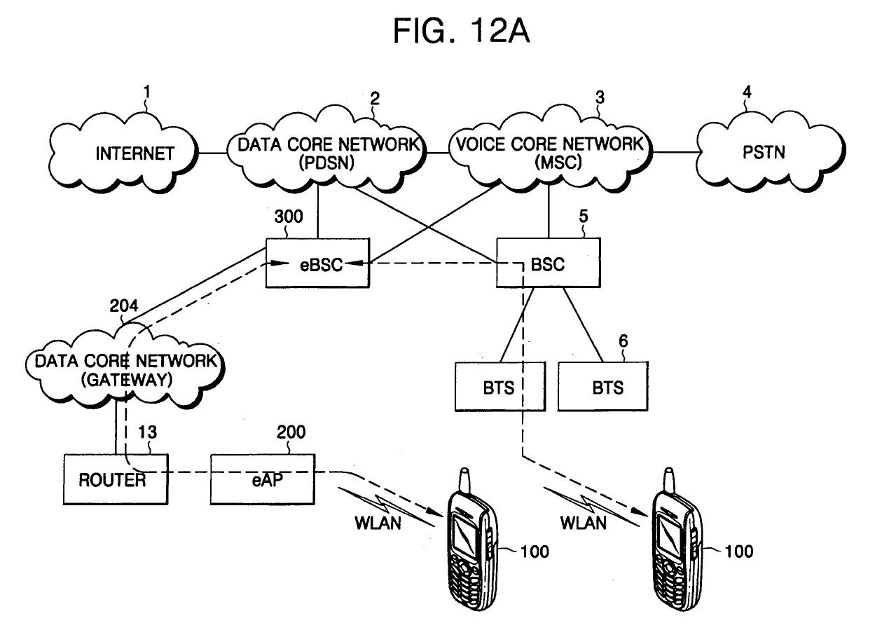

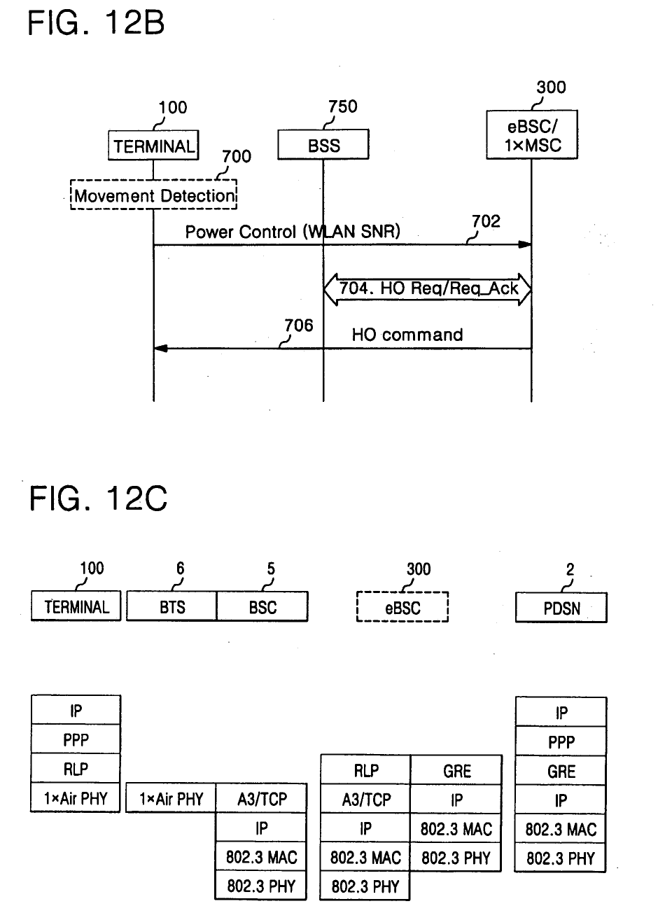

FIG. 12A shows a handover when the terminal moves from a wireless LAN network to a cellular network in the heterogeneous network where the tunnel is setup between the terminal and the eBSC.

As shown in FIG. 12A, after the terminal 100 connected to the cellular network through the eAP 200, the router 13, the gateway 12, and the eBSC 300, and receiving the communication service in the WLAN area moves to the cellular area, it receives the communication service through a new traffic channel connected through the BTS 6, the BSC 5, and the eBSC 300. Here, tunnel setup for creating a new traffic channel is not required. In FIG. 12A, handoff between the BSCs 5 is performed with the eBSC 300 serving as an anchor.

FIG. 12B is a call flowchart for performing the handover illustrated in FIG. 12A.

If the terminal 100 recognizes the need for a handover (Step 700), it requests a handover from the eBSC 300 (Step 702). Upon receipt of a request for handover, the eBSC 300 exchanges a handover request message and a response message with a BSS 750 setting up a new channel with the terminal 100 (Step 704), and transmits a signal instructing the terminal 100 to perform the handover (Step 706).

FIG. 12C shows a protocol stack for performing the handover of FIG. 12A.

An exemplary handover in the MSC 3, which is the second case of the handover in the heterogeneous network where the tunnel is setup between the terminal 100 and the eBSC 300, will now be described. This case illustrates a handover when the terminal 100 is connected with the PSTN through the MSC 3 and receives a voice service.

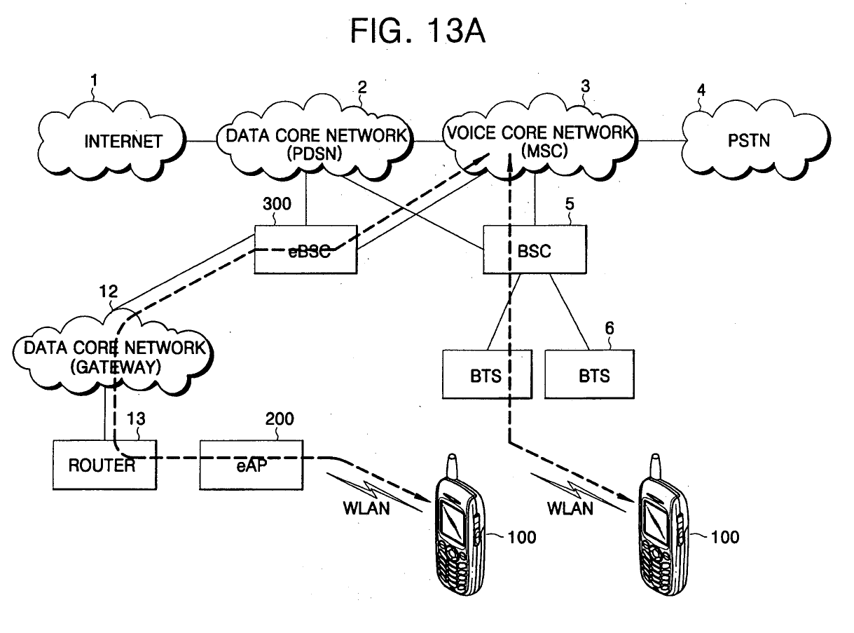

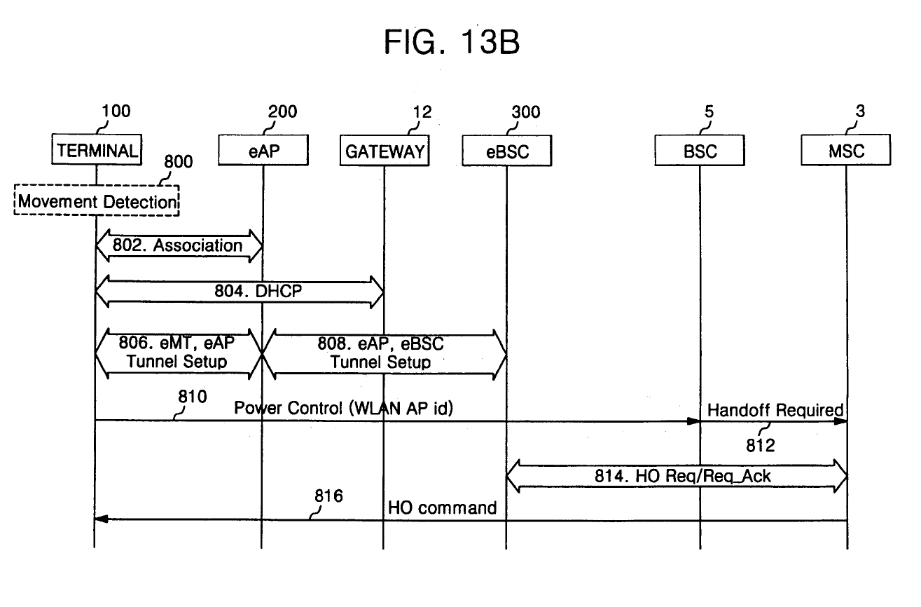

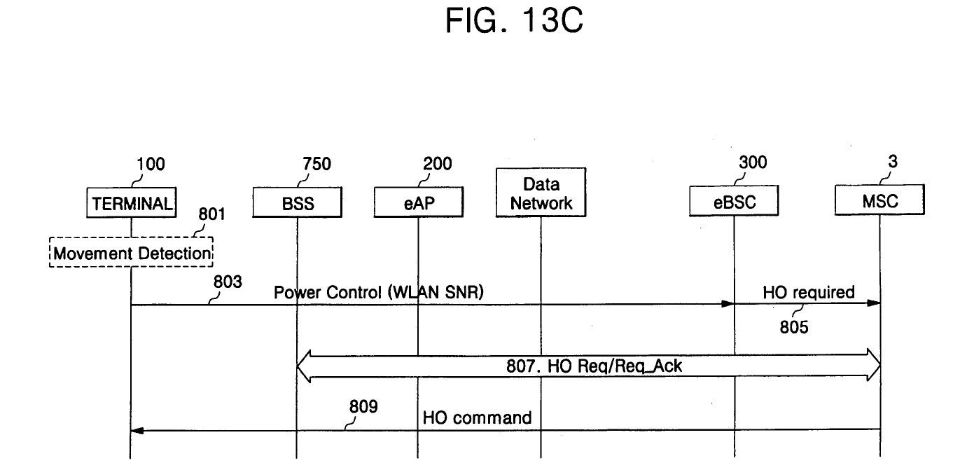

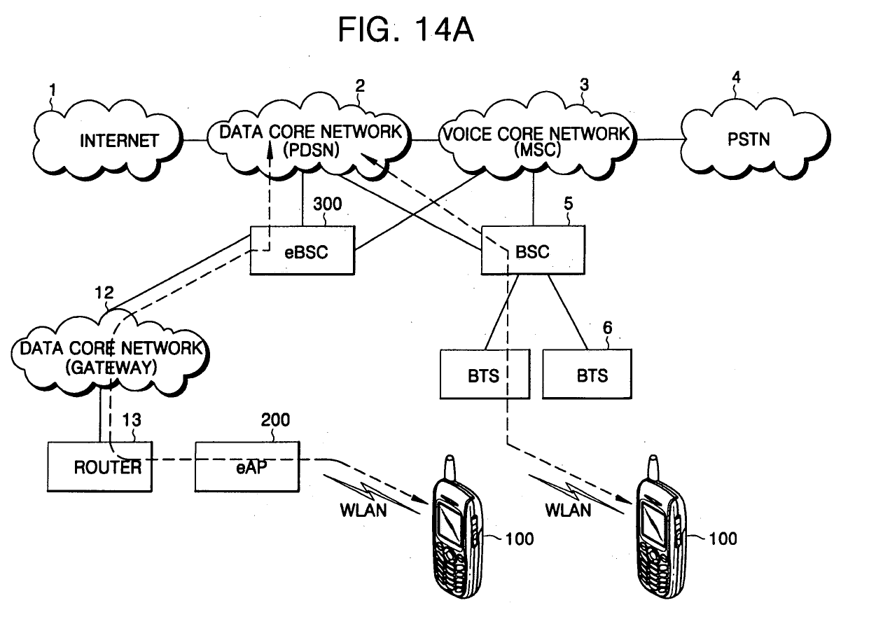

FIG. 13A shows a handover performed in the MSC for a terminal moving between a cellular network and a wireless LAN network.

As shown in FIG. 13A, the terminal 100 can be handed over between a channel connected with the MSC 3 through the eBSC 300 and a channel connected to the MSC 3 through the BSC 5.

This handover process will be described with reference to the call flowcharts of FIGS. 13B and 13C.

FIG. 13B is a call flowchart for a handover in a case where the terminal receiving the voice service in a cellular area in FIG. 13A moves to a WLAN area.

The terminal 100 connected to the BSC 5 and receiving the communication service detects weakening of the signal received from the BTS 6, thereby recognizing its area movement and the need for a handover (Step 800). Thus, the terminal 100 requests handover to the cellular area from the eBSC 300. The request of the terminal 100 to the eBSC 300 for the handover comprises an association with the eAP 200 (Step 802), an IP address assignment from the gateway 12 (Step 804), setup of a tunnel with the eAP 200 (Step 806), and setup of a tunnel between the eAP 200 and the eBSC 300 (Step 808).

When a tunnel with the eBSC 300 is setup, the terminal 100 transmits a message to the BSC 5 requesting handover to the eBSC 300 using a power control message (Step 810). This message is transmitted to the MSC 3 through the BSC 5 (Step 812). Upon receipt of the message, a handover request message and a response message are communicated between the MSC 3 and the eBSC 300 to be connected to the terminal 100 after the handover (Step 814). Upon receipt of the response message from the eBSC 300 permitting the handover, the MSC 3 transmits a signal to the terminal 100 instructing that data be transmitted using a new channel based on the handover (Step 816).

FIG. 13C is a call flowchart for a handover in a case where the terminal receiving the voice service in a WLAN area in FIG. 13A moves to a cellular area. The terminal 100 detects movement via a weakening of the signal (Step 801). A handover request is sent from terminal 100 to eBSC 300 via a power control message (Step 803). The eBSC 300 notifies the MSC 3 that a handover is required (Step 805). A handover request message and a response message are communicated between the MSC 3 and the BSS 750 to be connected to the terminal 100 after the handover (Step 807). Finally, a handover command is transmitted from the MSC 3 to the terminal 100.

Handover in the PDSN 2, which is the third case of the handover in the heterogeneous network where the tunnel is setup between the terminal 100 and the eBSC 300, will now be described. This is a case where the handover is performed while the terminal 100 receives data service.

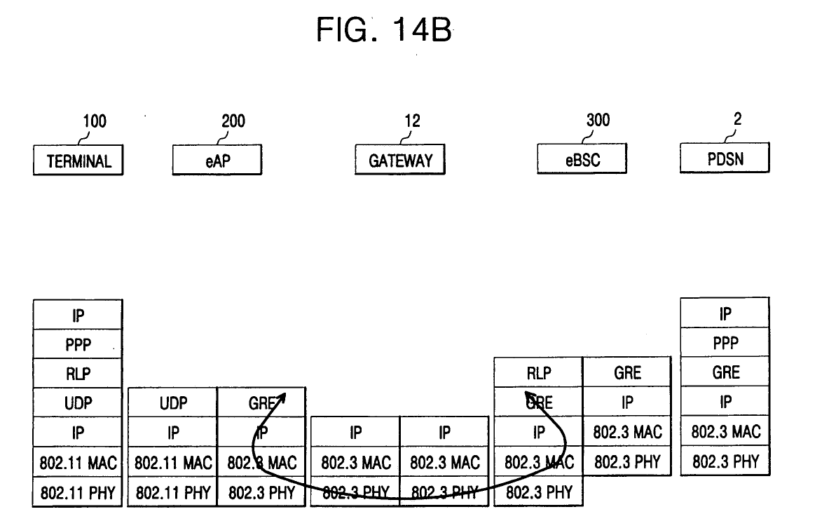

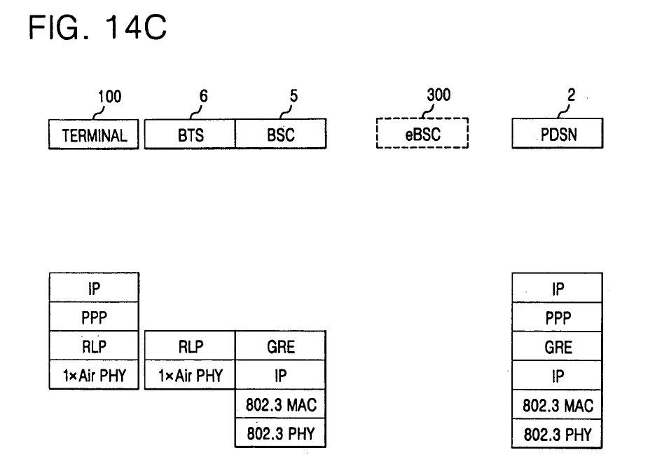

FIG. 14A shows a handover performed for a terminal moving between a cellular network and a WLAN network, in the PDSN.

The terminal 100 can be handed over between a channel connected to the PDSN 2 through an eBSC 300 and a channel connected to the PDSN 2 through a BSC 5.

FIG. 14B illustrates a protocol stack for a handover when the terminal receiving data service in a cellular area in FIG. 14A moves to a WLAN area, and FIG. 14C is a protocol stack for a handover when the terminal receiving data service in a WLAN area in FIG. 14A moves to a cellular area.

FIG. 14B shows a connection through a gateway 12 and an eAP 200 of a wireless LAN area, and FIG. 14C shows a connection through a BSC 5 and a BTS 6 of a cellular area.

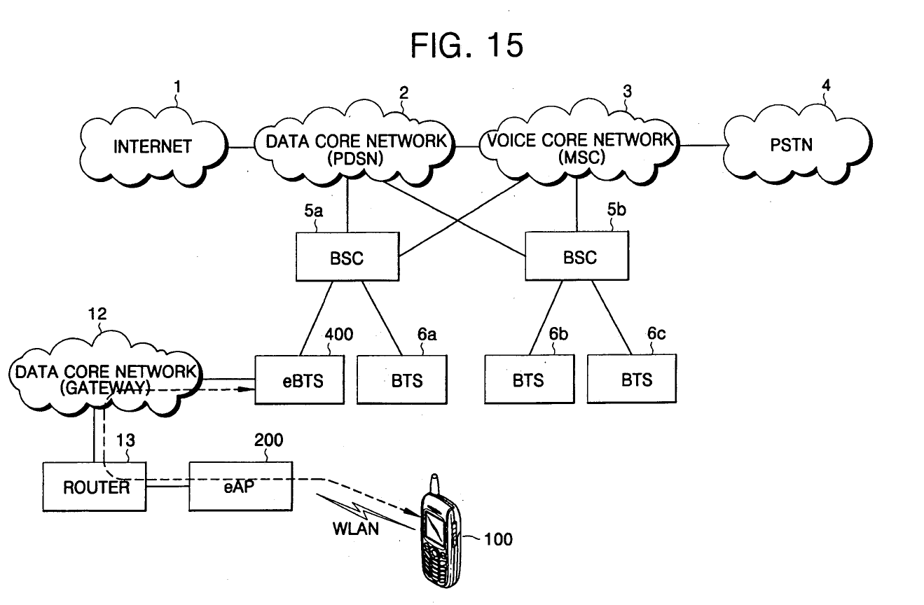

FIG. 15 illustrates an exemplary cellular mobile communication system for using a heterogeneous wireless network according to another embodiment of the present invention.

Referring to FIG. 15, the exemplary cellular mobile communication system includes a terminal 100 having a Wireless Local Area Network (WLAN) interface card mounted therein. An eAP 200 wirelessly communicates with the terminal 100 using a WLAN frequency and sets up a tunnel with the terminal 100. A switch or router 13 connects the eAP 200 to an external network. A gateway 12 connects the eAP 200 to the Internet through the switch or router 13. An eBTS 400 connects to the gateway 12 through a wired network, setting up a tunnel with the eAP 200 through the wired network, and provides a cellular service to the terminal 100 through the tunnel.

A Wireless Local Area Network (WLAN) interface module is mounted in the terminal 100 and processes a wireless signal at the WLAN frequency. The terminal 100 sets up a wireless link with the eAP 200 using the WLAN frequency in a WLAN area and performs wireless communication through the setup wireless link, and sets up a tunnel with the eAP 200 and connects to a cellular network through the tunnel.

Constructions of the terminal 100 and the eAP 200 are essentially the same as in FIGS. 4 and 5. However, in this exemplary embodiment, a call processor 230 of the eAP 200 (See FIG. 4) performs call processing so that the terminal 100 is connected to the eBTS 400 of the cellular network through the tunnel setup by the tunnel processor 220.

The eBTS 400 is connected to a Mobile Transceiver system (BSC) 5a. The BSC 5a is connected to a Mobile Station Controller (MSC) 3 which is a voice core network connected with a Public Switched Telephone Network (PSTN) 4 and performs voice communication. The BSC 5a is also connected to a Packet Data Serving Node (PDSN) 2 which is a data core network connected to the Internet 1 and performs data communication. The MSC 3 performs an exchange function for voice communication using the cellular mobile communication system, and the PDSN 2 performs a packet exchange function for data communication using the cellular mobile communication system.

The eBTS 400 sets up a wireless link with its managing terminals (not shown) using a cellular frequency, manages the setup wireless link, and provides a service for the terminal 100 connected through the WLAN.

In other words, the eBTS 400 sets up, maintains, and unassigns the wireless link for cellular terminals (not shown) for wireless communication using a cellular frequency band.

Further, the eBTS 400 receives information from the terminal 100 connected through the tunnel in the WLAN area, and transmits the received information to the MSC 3 or the PDSN 2 through the BSC 5a.

At this time, data and signaling transmission between the BSC 5a and the eBTS 400 is performed according to a standard (for example, Abis) or a common internal defining method of each equipment manufacturer (Inter Processor Communication (IPC)).

The BSC 5a recognizes the eBTS 400 as one of its sub BTSs, prepares information for the same cellular service, and transmits the information to the eBTS 400 using the Abis or a separate IPC. The eBTS 400 receives the information and transmits it using a tunnel previously setup with the terminal 100. In the same manner, the eBTS 400 receives information from the terminal 100 through the tunnel and transmits it to the BSC 5a through the Abis or the separate IPC.

The terminal 100 receives a beacon from the eAP 200, performs an association process for the eAP 200 using the received beacon, and is assigned an IP address from a gateway 12 using any suitable method including preferably Dynamic Host Configuration Protocol (DHCP). After that, the terminal 100 sets up a tunnel to the eAP 200 using a tunneling method such as User Datagram Protocol (UDP).

An exemplary method for setting up the tunnel between the terminal 100 and the eAP 200 will now be described in more detail.

After the terminal 100 sets up an association with the eAP 200 of the WLAN, the tunnel setup is attempted.

The tunnel can be setup manually by a manager or automatically at the terminal 100 and the eAP 200, respectively. Here, a process of automatically setting up the tunnel will be described in detail.

Depending on the method of setting up the tunnel between the terminal 100 and the eAP 200, various different embodiments can be realized. Here, an exemplary embodiment using a Media Access Control (MAC) address, an exemplary embodiment using an IP address, and an exemplary embodiment using an IP address and a User Datagram Protocol (UDP) port number together will each be described.

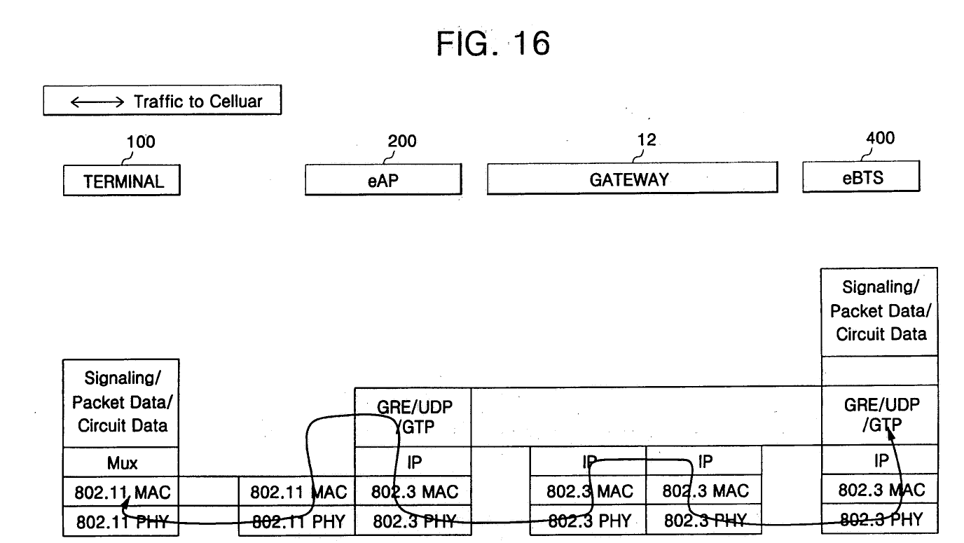

FIG. 16 shows a protocol stack structure of a cellular mobile communication system for using a heterogeneous wireless network according to an embodiment of the present invention.

The terminal 100 and the eAP 200 can communicate in the MAC layer without intermediate assistance of other networks. Accordingly, the eAP 200 and the terminal 100 can be aware of each other's MAC address. In a case where the terminal 100 and the eAP 200 previously determine whether to set up a tunnel setup, they setup the tunnel using their own MAC addresses without requiring any separate messages.

Otherwise, the terminal 100 transmits a tunnel connection setup request to the eAP 200, and then the eAP 200 transmits a tunnel connection permission message to the terminal 100.

After that, the eAP 200 transmits all traffic from or to the terminal 100 with which the tunnel is setup, to the tunnel with the eBTS 400.

Here, a multiplexing layer (Mux) is used to distinguish between signaling, packet data,and circuit data transmitted between the terminal 100 and the eBTS 400. For example, a Mux header having a total size of four bytes is preferably defined. One byte is preferably used as an identifier for distinguishing between signaling, packet data,and circuit data, and the remaining three bytes are left as a reserved field for future use.

Meanwhile, though not illustrated in the drawings, one terminal 100 can include two MAC addresses, one of which is designated to use the tunnel with the eBTS 400 and the other of which can be designated to use the IP data network.

In this case, if a MAC address received from the terminal 100 is designated to form a tunnel for the cellular service, the eAP 200 can transmit the MAC address to the eBTS 400 through the tunnel, and if it is designated for the IP data network, the eAP 200 can transmit the MAC address to the corresponding IP data network.

Next, an operation for setting up the tunnel between the eAP 200 and the eBTS 400 will be described.

The data and signaling transmission between the BSC 5a and the eBTS 400 is preferably performed according to the standard (for example, Abis) or the common internal defining method of each equipment manufacturer (Inter Processor Communication (IPC)).

The BSC 5a recognizes the eBTS 400 as one of its sub BTSs, prepares information for the same cellular service, and transmits the information to the eBTS 400 using the Abis or the separate IPC.

The eBTS 400 receives the information and transmits it using a tunnel previously setup with the terminal 100. In the same manner, the eBTS 400 receives information from the terminal 100 through the tunnel and transmits it to the BSC 5a through the Abis or the separate IPC.

After completion of the tunnel, the terminal 100 does not need to separately include a terminal ID and the user ID except in a special case. The BSC 5a regularly transmits information on the cell ID and states of other networks in the format of other information to both the BTSs 400 and 6a, and the eBTS 400 receives and transmits the information to the terminal 100 through the eAP 200 using the tunnel.

The terminal 100 periodically transmits a position registration message of the cellular service to the BSC 5a. Even when there is no data to be transmitted, the message must be transmitted to the eBTS 400 within a predetermined time in order to maintain the tunnel. If there is no tunnel maintenance message from the terminal 100, the eBTS 400 transmits a registration request message to the terminal 100 and waits for a predetermined time. As an example, when the eBTS 400 transmits the registration request message three times and does not receive a response, it instructs the eAP 200 to cancel the tunnel with the terminal 100.

Even when the terminal 100 does not receive periodic network information from the eBTS 400, it still transmits a message requesting network information and waits for a predetermined time. If there is no response after a predetermined time lapse, the terminal 100 repeats the same operation. For example, the terminal 100 may request network information three times, and if the network information is still not received, the terminal 100 cancels the tunnel with the eAP 200 and initiates a process of setting up a new tunnel.

A conventional BSC manages a BTS and performs a function of assigning a wireless channel to a terminal and controlling transmission output of a base station. Although the controlling of the transmission output of the base station in the BSC has no particular meaning in the context of a tunneled connection between an eBTS 400 and an eAP 200 of a WLAN, the BSC 5a according to an embodiment of the present invention can advantageously operate in a similar manner with other BTSs 6a, and recognize the eBTS 400 as having the same interface as the other BTSs 6a.

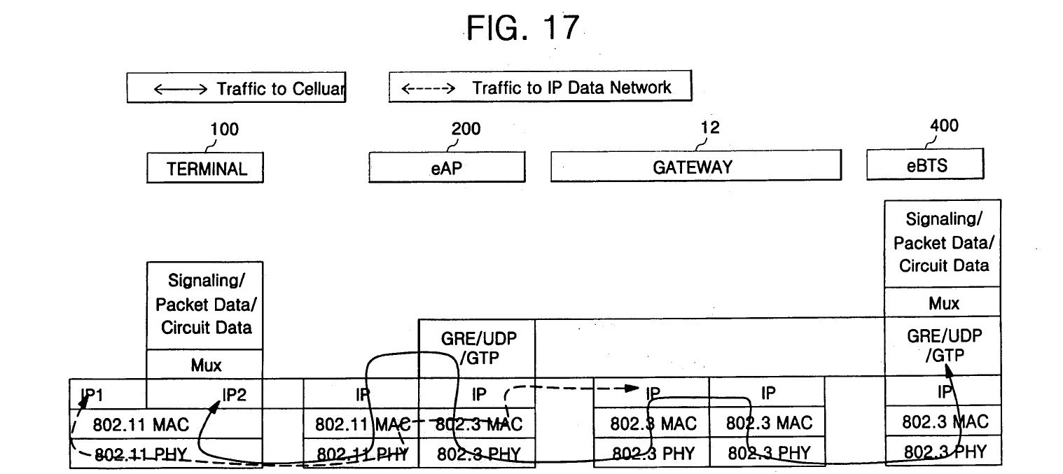

FIG. 17 shows a protocol stack structure of a cellular mobile communication system for using the heterogeneous wireless network according to another embodiment of the present invention.

Here, an operation for setting up a tunnel between the eAP 200 and the eBTS 400 is substantially the same as described with reference to FIG. 16.

An exemplary embodiment in which the tunnel is setup using the IP address between the terminal 100 and the eAP 200 will now be described with reference to FIG. 17.

As will be appreciated by those of ordinary skill in the art, the eAP 200 can be of a type where connection is made with an IP network using an IP address, or of a type where traffic of the eAP 200 is relayed to a router using a MAC bridge. Here, the type where connection is made with an IP network using an IP address will be described as an example.

In order to perform the tunnel setup using an IP address, the terminal 100 transmits a tunnel connection request message, together with an IP address of the terminal 100, to the eAP 200. The eAP 200 adds the IP address of the eAP 200 and transmits the tunnel connection permission message to the terminal 100.

As a result, the terminal 100 can distinguish between cellular traffic that should be transmitted to the cellular network and general IP data traffic that should be transmitted through the WLAN, using different IP addresses.

As an example, a case in which a first IP address is used for general IP data traffic that should be transmitted through the WLAN, and a second IP address is used for cellular traffic that should be transmitted to the cellular network, will now be described.

An IP packet having a header formed using the first IP address, transmitted from the terminal 100 to the eAP 200, is transmitted to the WLAN through the IP data network using the IP stack of the eAP 200 itself.

Meanwhile, an IP packet having a header formed using the second IP address, transmitted from the terminal 100 to the eAP 200, is mapped to a tunnel interface between the eAP 200 and the eBTS 400 by the tunnel setup, and transmitted to the cellular network. A multiplexing layer (Mux) is used to distinguish whether information transmitted between the terminal 100 and the eBTS 400 is signaling, packet data, or circuit data. For example, a Mux header preferably having a total size of four bytes is defined. One byte is preferably used as an identifier for distinguishing between the signaling, packet data, and circuit data, and the remaining three bytes are left as a reserved field for future use.

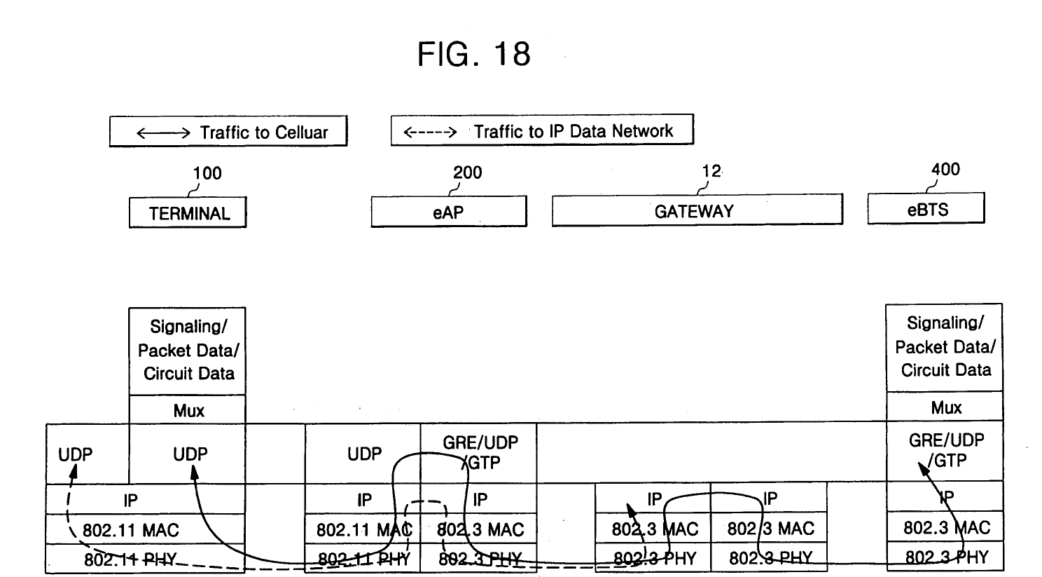

FIG. 18 shows a protocol stack structure of a cellular mobile communication system for using a heterogeneous wireless network according to another exemplary embodiment of the present invention.

Here, an operation for setting up a tunnel between the eAP 200 and the eBTS 400 is substantially the same as described with reference to FIG. 16.

An exemplary embodiment where the tunnel is setup using a IP address and a UDP port number together between the terminal 100 and the eAP 200 will be described with reference to FIG. 18.

In order to perform the tunnel setup between the terminal 100 and the eAP 200 using an IP address and a UPD port number, the terminal 100 adds the IP address of the terminal 100 and a range of the UPD port number requesting the tunnel setup, and transmits the tunnel connection request to the eAP 200.

The eAP 200 adds the IP address of the eAP 200 and a range of the UDP port number requesting the tunnel setup, and transmits the tunnel connection permission message to the terminal 100.

As a result, the terminal 100 can distinguish between cellular traffic and different IP data traffic using different UDP ports.

Traffic having a UDP header using UDP port numbers other than those designated for tunneling in a tunnel setup message is transmitted from the eAP 200 to the IP data network of the WLAN through its own IP stack.

Traffic having a UDP header using a UDP port number designated for tunneling in the tunnel setup message is mapped to the tunnel interface between the eAP 200 and the eBTS 400 by the tunnel setup and transmitted to the cellular network. A multiplexing layer (Mux) is used to distinguish whether information transmitted between the terminal 100 and the eBTS 400 is signaling, packet data, or circuit data. For example, a Mux header preferably having a total size of four bytes is defined. One byte is preferably used as an identifier for distinguishing between the signaling, packet data, and circuit data, and the remaining three bytes are left as a reserved field for future use.

A process of performing the cellular service in the terminal located in a WLAN area in the above-described communication system according to embodiments of the present invention will now be described.

First, connection between the eBTS 400, the BSC 5a, and the MSC 3 according to embodiments of the present invention is substantially the same as a conventional connection between the BTS 6b, the BSC 5b, and the MSC 3, and prefereably uses conventional message formats the same as messages communicated between the BTS 6b, the BSC 5b, and the MSC 3 for call processing.

In other words, in conventional systems, if the MSC 3 transmits a channel assignment request message to the BSC 5b, the BSC 5b commands the BTS 5b according to the channel assignment request message and assigns the wireless channel to the terminal, and if the BTS 6b assigns the wireless channel to the terminal, the BSC 5b performs a process for informing the MSC 3 that the wireless channel assignment has been successfully completed.

The conventional channel assignment request message communicated for channel assignment between the BTS 6b, the BSC 5b, and the MSC 3 can also be employed for communication between the eBTS 400, the BSC 5a, and the MSC 3 according to embodiments of the present invention. However, the channel assignment request message communicated between the eBTS 400, the BSC 5a, and the MSC 3 according to embodiments of the present invention can advantageously be limited to the format of a conventional channel assignment request message. This is because a conventional message for performing a command of assigning the wireless channel is not needed where the terminal 100 communicates with an eBTS 400 via a WLAN. Accordingly, although the channel assignment request message is communicated, processes of assigning the wireless resource of the cellular network as in the conventional cellular network are not needed. This is because according to exemplary embodiments of the present invention, the wireless link uses the wireless resource assigned from the WLAN.

Accordingly, the MSC 3 transmits the channel assignment request message to the eBTS 400 through the BSC 5a merely to report that the corresponding terminal is being called, and the eBTS 400 transmits a response message to the MSC 3 in response to the channel assignment request message merely to report that the terminal recognizes the fact that it is being called. An incoming call process will now be described.

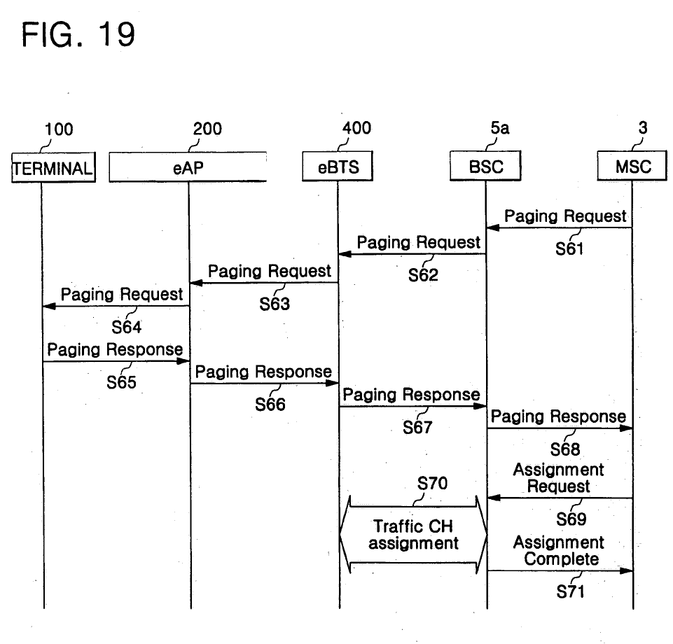

FIG. 19 is a call processing flowchart when there is an incoming call in the cellular mobile communication system using the heterogeneous wireless network according to an embodiment of the present invention.

Referring to FIG. 19, if the BSC 5a receives a paging request message from the MSC 3 (Step 61), it transmits the paging request message to the eBTS 400, and the eBTS 400 transmits the paging request message to the eAP 200 through the setup tunnel (Step 63). The eAP 200 then transmits the paging request message to the terminal 100 through the setup tunnel (Step 64).

If the terminal 100 responds with a paging response message (Step 65), the eAP 200 transmits the paging response message to the eBTS 400 through the setup tunnel (Step 66), and the eBTS 400 transmits the paging response message to the BSC 5a (Step 67). After the BSC 5a confirms this response, it transmits the paging response message to the MSC 3 (Step 68). The paging response message includes information on BSC's requesting to setup a trunk channel with the MSC. In response, the MSC 3 transmits the channel assignment request message while completing setup of the trunk channel with the BSC 5a (Step 69).

The BSC 5a performs a channel assignment process according to a conventional call setup process (S70). The eBTS 400 receives this message and finishes preparing for transmission through an earlier tunnel with the terminal 100 using the circuit data Mux header, and transmits a channel assignment confirmation message to the BSC 5a. The BSC 5a receives the channel assignment confirmation message and transmits a channel assignment complete message to the MSC 3 (Step 71). Next, the MSC 3 completes a remaining call process and communicates a PCM voice signal with the BSC 5a using time division multiplexing (TDM) or the like. The BSC 5a converts this voice signal into the Enhanced Variable Rate Codec (EVRC), and transmits the voicesignal to the eBTS 400 using a standard such as Abis. The eBTS 400 communicates the voice signal with the terminal 100 using the circuit data Mux header.

Next, an outgoing call process, for example, for CDMA 2000 will be described.

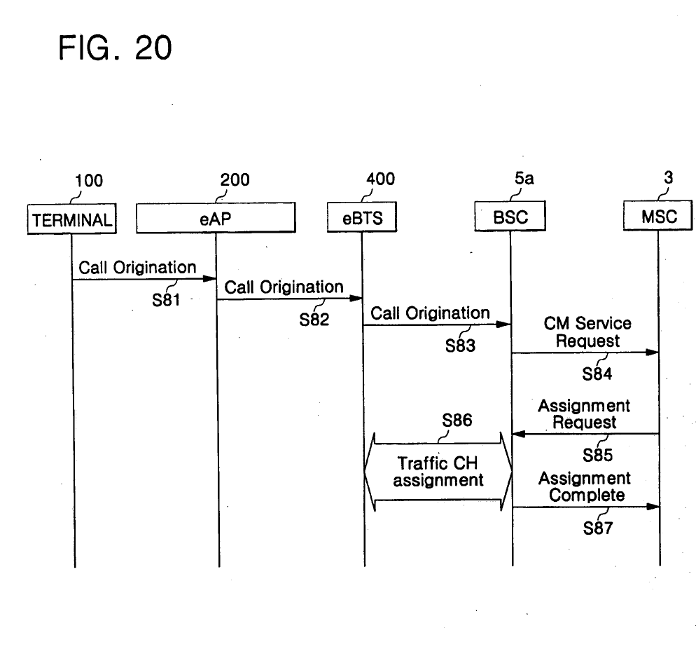

FIG. 20 is a call processing flowchart when there is an outgoing call in the cellular mobile communication system using a heterogeneous wireless network according to an embodiment of the present invention.

Referring to FIG. 20, the terminal 100 transmits an origination message to the eAP 200 using a predetermined tunnel (Step 81). The eAP 200 receives the origination message and transmits it to the eBTS 400 using the predetermined tunnel (Step 82). The eBTS 400 receives the origination message and transmits it to the BSC 5a using a standard such as Abis (Step 83). The BSC 5a receives the origination message, transmits a CM service request message to the MSC 3, and requests assignment of a channel (Step 84). The MSC 3 responds to the BSC 5a with the channel assignment request message (Step 85), and completes setup of the channel between the MSC 3 and the BSC 5a, and the BSC 5a transmits the channel assignment complete message to the eBTS 400 (Step 86).

After the eBTS 400 finishes preparing for transmission of the voice signal through the tunnel using the circuit data Mux header, according to the conventional call setup process, it reports that a CDMA air channel assignment is completed as required by the BSC 5a through the Abis. However, as mentioned above, it is important to understand that a CDMA air channel is not actually assigned, because the wireless resource of the WLAN is assigned by the WLAN. The BSC 5a receives this message, and transmits the channel assignment complete message to the MSC 3 (Step 87). After that, the MSC 3 completes the remaining call process and communicates the PCM voice signal with the BSC 5a using TDM or the like. The BSC 5a converts the voice signal into EVRC and communicates the converted voice signal with the eBTS 400 through a standard such as Abis. The eBTS 400 communicates the EVRC-formatted voice information with the terminal 100 using a UDP port setup through the above-described process.

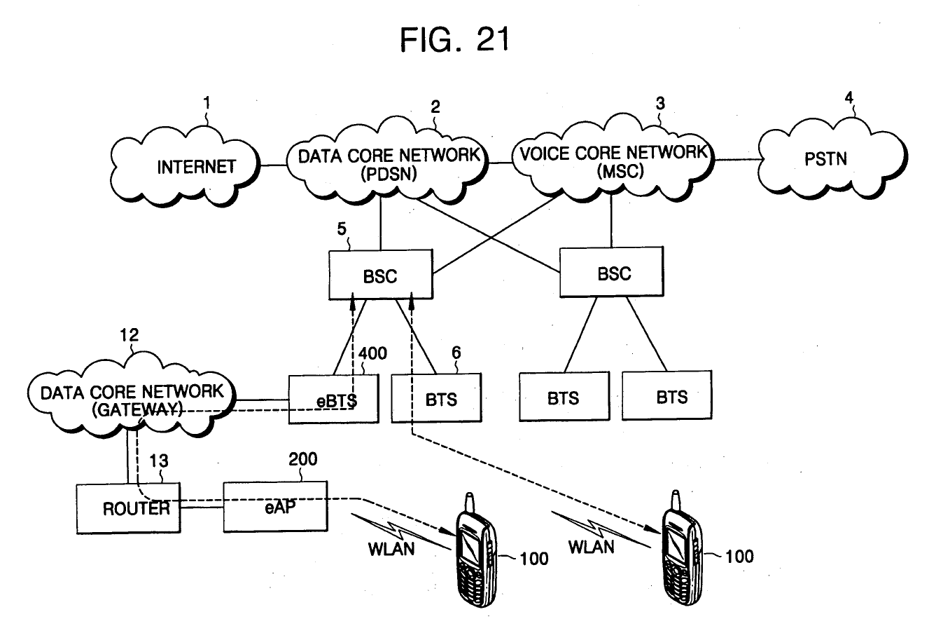

FIG. 21 shows a handover when the terminal moves between the cellular network and the WLAN network.

This handover can be processed in the same manner as the handover between the BTSs with the BSC 5 being the anchor, except that the new channel setup after the handover includes the tunnel setup process. This is because the BSC 5 can communicate with the eBTS 400 according to the same method as the BTS 6, in the heterogeneous network where the tunnel is setup between the terminal 100 and the eBTS 400. Here, the terminal 100 and the eBTS 400 each setup a tunnel targeting the eAP 200. The tunnel setup is described above. In other words, if the terminal 100 moves to the WLAN area managed by a new eAP 200, thereby requiring creation of a new channel through the eAP 200 for the handover, the terminal 100 requests the new eAP 200 to setup the tunnel. Upon receipt of the request for the tunnel setup from the terminal 100, the eAP 200 performs the tunnel setup with the eBTS 400 with which the terminal 100 intends to communicate, so that the terminal 100 and the eBTS 400 can communicate data with each other.

In the above described exemplary embodiments of the present invention, the method for setting up the tunnel between the terminal 100 and the eAP 200 was described for the cases of using a MAC address, using an IP address, and using an IP address and a UDP port number together.

In addition, although not described above, the tunnel can also be setup between the terminal and the eAP using any suitable method including a User Datagram Protocol (UDP), a Generic Route Encapsulation (GRE) protocol, or a General Packet Radio Service Transfer Protocol (GTP).

In addition, in the above described exemplary embodiments of the present invention, the cellular mobile communication system using a heterogeneous wireless network provides a cellular service using a wireless resource of a WLAN. Alternatively, the cellular service can be provided using a wireless resource such as Bluetooth or any other suitable wireless technology.

Moreover, in the above described exemplary embodiments of the present invention, when the eAP and the eBSC setup a tunnel, and when the eAP and the eBTS setup a tunnel, tunnel setup using UDP is described. However, as will be appreciated by those of ordinary skill in the art, tunnel setup can also be performed using GRE, GTP, or any other suitable method.

According to embodiments of the present invention, if a terminal capable of using the cellular frequency band has a WLAN interface module and is in a WLAN service area, the terminal can be connected to the cellular service network using the WLAN service-dedicated wireless resource, without using the cellular service-dedicated wireless resource, thereby enabling it to utilize the cellular service while conserving cellular network resources.

Furthermore, since embodiments of the present invention enable a WLAN system to be associated with a cellular mobile communication system, it makes various communication services possible. For example, since the terminal is connected to the cellular service network using the WLAN service-dedicated wireless resource, thereby enabling it to utilize the cellular service, embodiments of the present invention also provide an opportunity for service providers to attract WLAN subscribers as clients.

Furthermore, embodiments of the present invention support handover, thereby enabling mobility of the terminal in a heterogeneous wireless network.

While the present invention has been described with reference to exemplary embodiments thereof, it will be understood by those skilled in the art that various changes in form and detail may be made therein without departing from the spirit and scope of the present invention as defined by the following claims.

What is claimed is:

1. A cellular mobile communication system for using a heterogeneous wireless network, the system comprising:
an access point of a wireless Local Area Network (LAN) for providing a wireless resource using a wireless LAN-dedicated frequency;
a base station of a cellular network connected to the access point through a wired network by a first tunnel; and
a terminal adapted to set up a second tunnel with the access point for using the wireless resource provided from the access point, and connecting to the cellular network through the first and second tunnels to perform call processing.

2. The system according to claim 1, wherein the base station of the cellular network and the access point setup the first tunnel using one of a User Datagram Protocol (UDP), a Generic Route Encapsulation (GRE) protocol, and a General Packet Radio Service Transfer Protocol (GTP).

3. The system according to claim 1, wherein the tunnel is setup between the terminal and the access point using a Media Access Control (MAC) address.

4. The system according to claim 1, wherein the tunnel is setup between the terminal and the access point using an Internet Protocol (IP) address.

5. The system according to claim 1, wherein the tunnel is setup between the terminal and the access point using an IP address and a UDP port number together.

6. The system according to claim 1, wherein the terminal and the base station of the cellular network use a multiplexing layer (Mux) header to distinguish whether information transmitted between the terminal and the base station of the cellular network is signaling, packet data, or circuit data.

7. A terminal for a cellular mobile communication system for using a heterogeneous wireless network, the terminal comprising:
a Wireless Local Area Network (WLAN) interface module assigned a wireless resource from a WLAN and communicating with the WLAN using a WLAN-dedicated frequency band, wherein the WLAN sets up a first tunnel with a cellular network;
a tunnel processor for setting up and managing a second tunnel with the WLAN, using the wireless resource provided from the WLAN through the WLAN interface module; and
a call processor connected to the cellular network through the first and second tunnels for performing call processing.

8. The terminal according to claim 7, further comprising a cellular interface module for being assigned the wireless resource from the cellular network and communicating with the cellular network using a cellular-dedicated frequency band.

9. The terminal according to claim 7, wherein the tunnel processor sets up the second tunnel with the WLAN using one of a User Datagram Protocol (UDP), a Generic Route Encapsulation (GRE) protocol, and a General Packet Radio Service Transfer Protocol (GTP).

10. A cellular mobile communication method for using a heterogeneous wireless network, the method comprising the steps of:
setting up a first tunnel with a base station of a cellular network connected through a wired network in an access point of a wireless Local Area Network (WLAN),;
setting up a second tunnel with a terminal connected through a wireless link in the access point of the WLAN; and
connecting the terminal to the cellular network through the first and second tunnels and performing call processing.

11. The method according to claim 10, wherein the second tunnel is setup between the terminal and the access point using a Media Access Control (MAC) address.

12. The method according to claim 10, wherein the second tunnel is setup between the terminal and the access point using an Internet Protocol (IP) address.

13. The method according to claim 10, wherein the second tunnel is setup between the terminal and the access point using a MAC address and a UDP port number together.

14. The method according to claim 10, wherein the terminal and the base station of the cellular network use a multiplexing layer (Mux) header to distinguish whether information transmitted between the terminal and the base station of the cellular network is signaling, packet data, or circuit data.

15. A handover device of a cellular mobile communication system for using a heterogeneous wireless network, the system comprising:
an access point of a wireless Local Area Network (WLAN) for providing a wireless resource using a wireless LAN-dedicated frequency;
a base station of a cellular network connected with the access point through a wired network by a first tunnel; and
a terminal adapted to set up a second tunnel with the access point using the wireless resource provided from the access point, to connect to the cellular network through the first and second tunnels or using a wireless resource provided from the cellular network, and, if it is determined that a handover is required, setting up a new channel according to the handover and connecting to the cellular network through the new channel.

16. The device according to claim 15, wherein when an intensity of a received signal is less than a predetermined critical value, the terminal determines that the handover is required.

17. The device according to claim 15, wherein either of the first tunnel and the second tunnel is setup using one of a User Datagram Protocol (UDP), a Generic Route Encapsulation (GRE) protocol, and a General Packet Radio Service Transfer Protocol (GTP).

18. The device according to claim 15, wherein the terminal unassigns an earlier channel after creation of the new channel is completed.

19. The device according to claim 15, wherein, before transmitting data to a device of a new cellular network connected through the new channel, the terminal transmits a first message to a device of a cellular network connected through an earlier channel informing the cellular network that data will be transmitted through the new channel.

20. The device according to claim 19, wherein the first message is transmitted using a power control message.

21. The device according to claim 19, wherein the first message has information on the new channel.

22. A handover method in a cellular mobile communication system for using a heterogeneous wireless network where a cellular network and a wireless LAN are connected through a tunnel, the method comprising the steps of:
determining whether or not the terminal needs a handover;
when it is determined that the terminal needs a handover, setting up a first tunnel with the wireless LAN in order to create a new channel to be used for data transmission after the handover;
setting up a second tunnel for connecting the wireless LAN with the cellular network; and
communicating data with the cellular network through the created new channel having the first and second tunnels.

23. The method according to claim 22, further comprising the step of unassigning an existing channel before the handover.
